(19) United States
(12) Patent Application Publication
(10) Pub. No.: US 2024/0349338 A1
(43) Pub. Date: Oct. 17, 2024

(54) FULL DUPLEX FEASIBILITY AWARE SIDELINK RESOURCE SELECTION

(71) Applicant: QUALCOMM Incorporated, San Diego, CA (US)

(72) Inventors: Yan ZHOU, San Diego, CA (US); Hemant SAGGAR, San Diego, CA (US); Tao LUO, San Diego, CA (US); Junyi LI, Fairless Hills, PA (US); Navid ABEDINI, Basking Ridge, NJ (US); Jelena DAMNJANOVIC, Del Mar, CA (US); Sony AKKARAKARAN, Poway, CA (US); Jing SUN, San Diego, CA (US)

(21) Appl. No.: 18/301,198

(22) Filed: Apr. 14, 2023

(51) Int. Cl. H04W 74/08; H04W 72/1263; H04W 72/54

(52) U.S. Cl. CPC H04W 74/0816; H04W 72/1263; H04W 72/54; H04L 5/14

(57) ABSTRACT

A method for wireless communication at a user equipment (UE) and related apparatus are provided. In the method, a UE monitors for sidelink resource reservations in slots belonging to a sidelink resource pool during a sensing window including one or more slots in which the UE transmits, an inclusion of the one or more slots being based on a condition for sidelink FD communication, and transmits a sidelink transmission using a resource selected from a subset of candidate sidelink resources in the sidelink resource pool after monitoring for the sidelink resource reservations. The method improves the efficiency and performance of SL communication by enabling FD operation and facilitating better resource selection and channel prioritization.

### TECHNICAL FIELD

The present disclosure relates generally to communication systems, and more particularly, to sidelink sensing and resource selection for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to monitor for sidelink resource reservations in slots belonging to a sidelink resource pool during a sensing window, including one or more slots in which the UE transmits, the inclusion of the one or more slots being based on a condition for sidelink FD communication; and transmit a sidelink transmission using a resource selected from a subset of candidate sidelink resources in the sidelink resource pool after monitoring for the sidelink resource reservations.

In an aspect of the disclosure, a method, a computer-readable medium, and an apparatus are provided for wireless communication at a UE. The apparatus may include memory and at least one processor coupled to the memory. Based at least in part on information stored in the memory, the at least one processor may be configured to receive scheduling for a first set of transmissions to be received by the UE that will overlap in time with a second set of transmissions to be transmitted by the UE; select a first transmission from the first set of transmissions and a second transmission from the second set of transmissions for FD transmission and reception based on FD compatibility of transmission and reception beams and priority of the first transmission and the second transmission; and receive the first transmission while transmitting the second transmission based on FD operation.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with aspects presented herein.

FIG. 2 illustrates example aspects of a sidelink slot structure, in accordance with aspects presented herein.

FIG. 3 is a diagram illustrating an example of a first device and a second device that support wireless communication based on sidelink, in accordance with aspects presented herein.

FIG. 4A is a diagram illustrating an example of sidelink communication between multiple UEs, in accordance with aspects presented herein.

FIG. 4B is a diagram illustrating an example of a UE transmits and receives via various beams, in accordance with aspects presented herein.

FIG. 5 is an example of time and frequency resources showing reservations for sidelink transmissions, in accordance with aspects presented herein.

FIG. 6 is a diagram illustrating an example of a sensing and resource selection timeline, in accordance with aspects presented herein.

FIG. 7A is a diagram illustrating an example of resource exclusion based on the half-duplex (HD) assumption, in accordance with aspects presented herein.

FIG. 7B is a diagram illustrating an example of FD aware sidelink resource selection in accordance with various aspects of the present disclosure.

FIG. 8 is a diagram illustrating an example of determining FD feasibility in accordance with various aspects of the present disclosure.

FIG. 9 is a diagram illustrating an example of a dedicated SI measurement resource in accordance with various aspects of the present disclosure.

FIG. 10 is a diagram illustrating an example of determining the FD feasibility of an SL UE in accordance with various aspects of the present disclosure.

FIG. 11 is a diagram illustrating an example of determining the FD feasibility of an SL UE in accordance with various aspects of the present disclosure.

FIG. 12 is a diagram illustrating an example of determining the FD feasibility within allowed resource in accordance with various aspects of the present disclosure.

FIG. 13 is a diagram illustrating an example of channel prioritization under the HD assumption, in accordance with aspects presented herein.

FIG. 14 is a diagram illustrating an example of FD aware SL channel prioritization in accordance with various aspects of the present disclosure.

FIG. 15 is a call flow diagram illustrating a method of wireless communication in accordance with various aspects of the present disclosure.

FIG. 16 is a call flow diagram illustrating a method of wireless communication in accordance with various aspects of the present disclosure.

FIG. 17 is a flowchart illustrating methods of wireless communication at a UE in accordance with various aspects of the present disclosure.

FIG. 18 is a flowchart illustrating methods of wireless communication at a UE in accordance with various aspects of the present disclosure.

FIG. 19 is a flowchart illustrating methods of wireless communication at a UE in accordance with various aspects of the present disclosure.

FIG. 20 is a flowchart illustrating methods of wireless communication at a UE in accordance with various aspects of the present disclosure.

FIG. 21 is a diagram illustrating an example of a hardware implementation for an example apparatus and/or UE, in accordance with aspects presented herein.

### DETAILED DESCRIPTION

Various aspects relate generally to wireless communication systems. Some aspects more specifically relate to sidelink sensing and sidelink resource selection based on full-duplex (FD) communication conditions. In some examples, a UE monitors for sidelink resource reservations in slots belonging to a sidelink resource pool during a sensing window. As presented herein, the UE may include one or more slots in which the UE transmits in sidelink sensing, the inclusion of the one or more slots being based on a condition for sidelink FD communication. The condition may be referred to as FD feasibility in the slots being monitored, in some aspects. Under some conditions, the UE may select resources for simultaneous sidelink transmission and reception. When a UE is scheduled to a set of channels or reference signals for transmission that overlaps with a set of channels or reference signals for reception, the UE may consider priority of the channels or reference signals and the full-duplex capability of a beam pair combination for the transmission and reception.

Particular aspects of the subject matter described in this disclosure can be implemented to realize one or more of the following potential advantages. In some examples, by enabling FD operation and facilitating better resource selection and channel prioritization, the described techniques can be used to improves the efficient use of sidelink wireless resources, reduce latency, and improve performance of SL communication. In some aspects, by allowing FD-capable UEs to utilize additional resources in the sensing window, even if the UE is transmitting data in some of those resources, the described techniques can be used to increase the overall resource utilization in SL communication. In some aspects, by adopting an improved channel prioritization procedure to select the best combination of Tx and Rx channels for FD operation, the described techniques can be used to improve overall SL channel quality and throughput.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks. components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

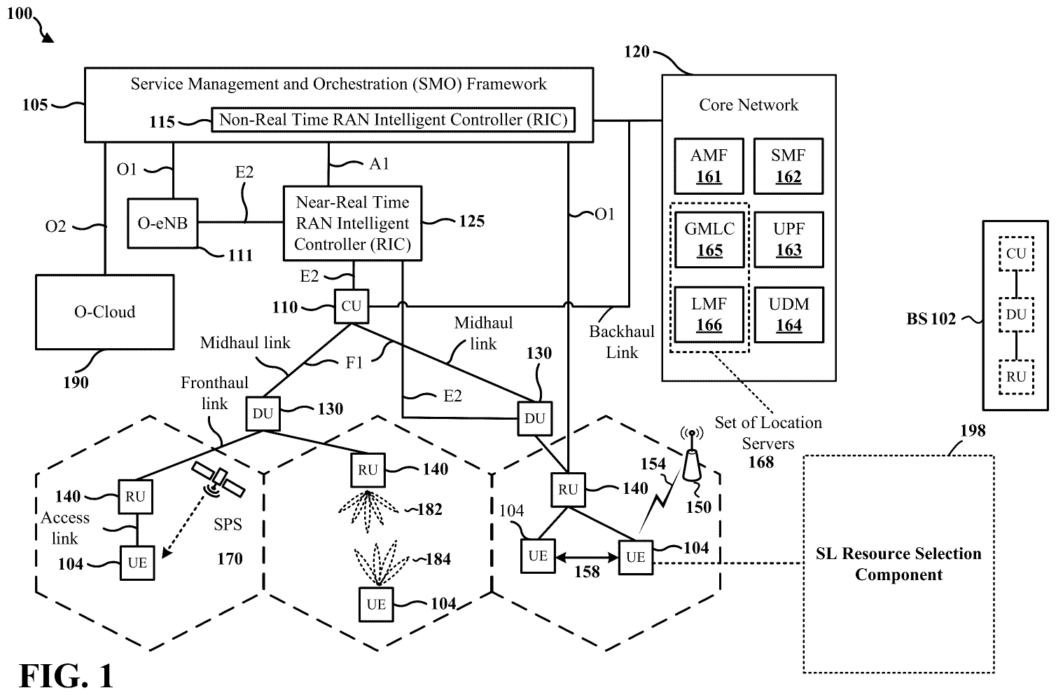

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN clements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other directly using device-to-device (D2D) communication link 158. The D2D communication link 158 may use the DL/UL wireless wide area network (WWAN) spectrum, in some aspects. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH), or a physical sidelink feedback channel (PSFCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

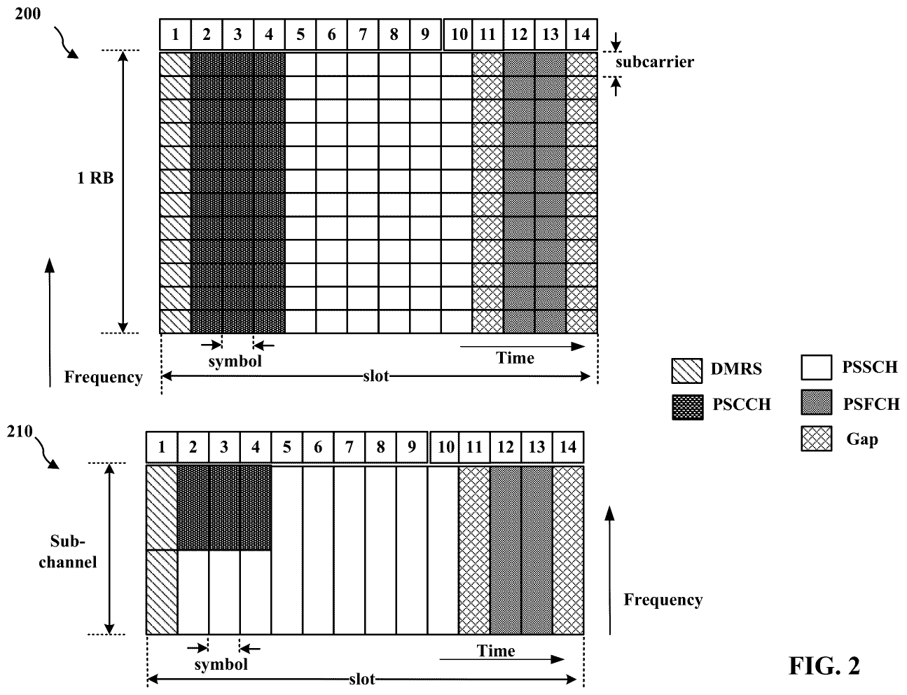

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSc), etc. In addition to UEs, sidelink communication may also be transmitted and received by other transmitting and receiving devices, such as Road Side Unit (RSU), etc. Sidelink communication may be exchanged using a PC5 interface, such as described in connection with the example in FIG. 2, in some aspects. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may cach include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an SL resource selection component 198. In some aspects, the SL resource selection component 198 may be configured to monitor for sidelink resource reservations in slots belonging to a sidelink resource pool during a sensing window including one or more slots in which the UE transmits, an inclusion of the one or more slots being based on a condition for sidelink FD communication; and transmit a sidelink transmission using a resource selected from a subset of candidate sidelink resources in the sidelink resource pool after monitoring for the sidelink resource reservations. In some aspects, the SL resource selection component 198 may be configured to receive scheduling for a first set of transmissions to be received by the UE that will overlap in time with a second set of transmissions to be transmitted by the UE; select a first transmission from the first set of transmissions and a second transmission from the second set of transmissions for FD transmission and reception based on FD compatibility of transmission and reception beams and priority of the first transmission and the second transmission; and receive the first transmission while transmitting the second transmission based on FD operation. Example aspects presented herein are related to improving resource selection and channel prioritization for sidelink FD communication and aim to increase resource utilization and efficiency in sidelink communication.

FIG. 2 includes diagrams 200 and 210 illustrating example aspects of slot structures that may be used for sidelink communication (e.g., between UEs 104, RSU, etc.). The slot structure may be within, or may use aspects of, a 5G/NR frame structure in some examples. In other examples, the slot structure may be within an LTE frame structure. As an example, CV2X communication may use an LTE frame structure, in some aspects. Although the following description may be focused on 5G NR, the concepts described herein may be applicable to other similar arcas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, cach slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. In some aspects, the PSCCH may include a first portion of sidelink control information (SCI) that may be referred to as SCI-I, and the PSSCH may include a second portion of SCI that may be referred to as SCI-2. The SCI may indicate information for a receiver to receive a data transmission in PSSCH. In some aspects, the SCI may indicate the resources on which the PSSCH will be transmitted. In such aspects, the SCI may be referred to as including a resource reservation.

A resource grid may be used to represent the frame structure. Each time slot may include a resource block (RB) (also referred to as physical RBs (PRBs)) that extends 12 consecutive subcarriers. The resource grid is divided into multiple resource clements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

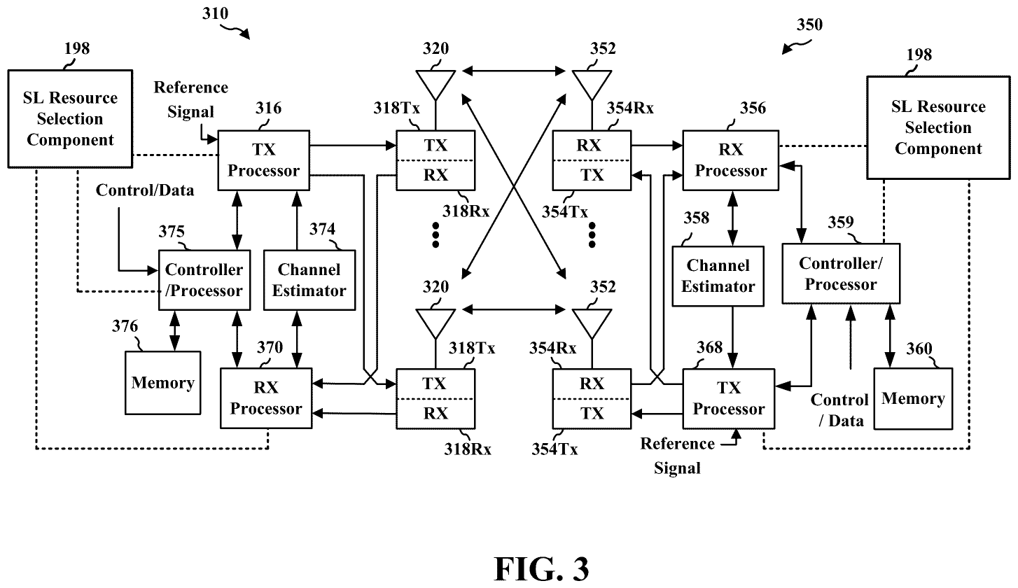

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving. rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, cach receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the SL resource selection component 198 of FIG. 1.

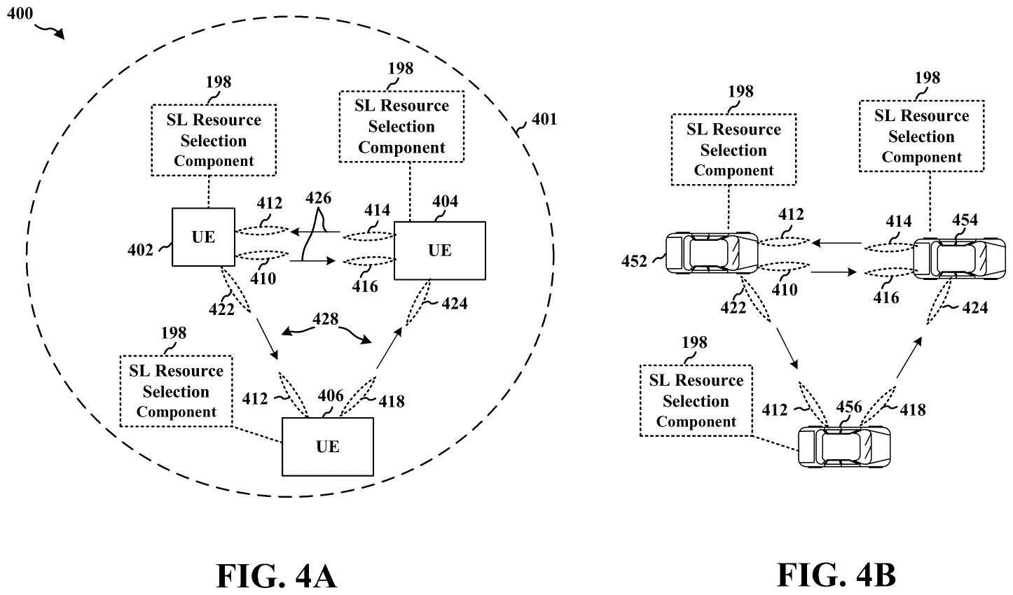

FIG. 4A illustrates an example 400 of sidelink communication between UEs 402, 404, and 406. The communication may be based on a slot structure comprising aspects described in connection with FIG. 2. For example, the UE 402 may transmit a sidelink transmission, e.g., comprising a control channel (e.g., PSCCH) and/or a corresponding data channel (e.g., PSSCH), that may be received by UEs 404 and/or 406. A control channel may include information (e.g., SCI) for decoding the data transmission (e.g., PSSCH) including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, and 406 may cach be capable of sidelink transmission in addition to sidelink reception. The sidelink transmissions may be unicast, broadcast or multicast to nearby devices. For example, UE 402 may transmit communication intended for receipt by other UEs within a range 401 of UE 402. Additionally, or alternatively, the UE 404 or UE 406 may transmit sidelink transmissions. The sidelink transmissions, as well as other types of wireless transmissions, may be transmitted as directional beams, e.g., as described in connection with 182 and 184 in FIG. 1. For example, FIG. 4B illustrates an example in which the UE 402 transmits using beams 410 and 422 and receives via a beam 412. The UE 404 transmits using beam 414 and receives using beams 416 and 424. The UE 406 transmits using beam 418 and receives using beam 412. One or more of the UEs 402, 404, and 406 may comprise an SL resource selection component 198 as described in connection with FIG. 1. In some aspects, a UE exchanging sidelink communication may be associated with, comprised in, or located at a vehicle. FIG. 4B illustrates an example of sidelink communication as described in FIG. 4A between UEs associated with vehicles, e.g., UE 452, 454, and 456. As an example, the UEs 452, 454, and 456 may exchange V2X communication. As described in connection with FIG. 1, a UE may support communication based on sidelink and Uu communication, such as reception of downlink transmission and transmission of uplink transmissions with a base station.

In some aspects, sidelink communication may be based on HD communication, where the UEs 402, 404, 406, 452, 454, and/or 456 transmit and receive at different times, e.g., without simultaneous transmission and reception. In some aspects one or more of the UEs 402, 404, 406, 452, 454, and/or 456 may support FD communication, e.g. in which the UE transmits and receives simultaneously (e.g., overlapping at least partially in time) and in a same frequency range. FD communication may enable more efficient resource utilization and reduce latency for communication. In such an example, the links 426 may be FD links between the UE 402 and the UE 404. The links 428 may be FD links for the UE 406.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 (e.g., UE 402, 404, 406, 452, 454, or 456) to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

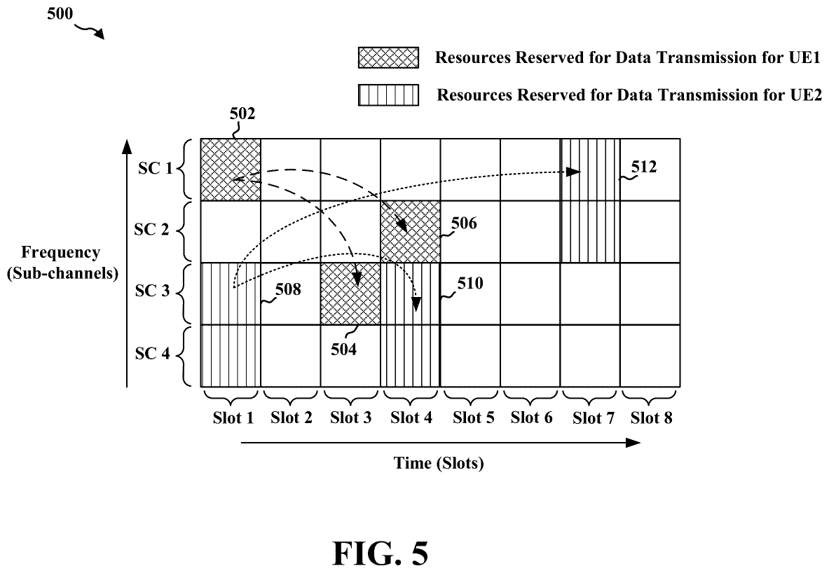

FIG. 5 is an example 500 of time and frequency resources showing reservations for sidelink transmissions. The resources may be comprised in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1”) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions. UE1 then transmits information regarding which resources are being used and/or reserved by it to other UE(s). UE1 may do by including the reservation information in the reservation resource field of the SCI, e.g., a first stage SCI.

FIG. 5 illustrates that a second UE (“UE2”) reserves resources in sub-channels SC 3 and SC 4 at time slot 1 for its current data transmission (at 508), and reserve first data retransmission (at 510) at time slot 4 using sub-channels SC 3 and SC 4, and reserve second data retransmission (at 512) at time slot 7 using sub-channels SC 1 and SC 2 as shown by FIG. 5. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5, the UE may transmit SCI reserving resources for data transmissions (at 508, 510, and 512).

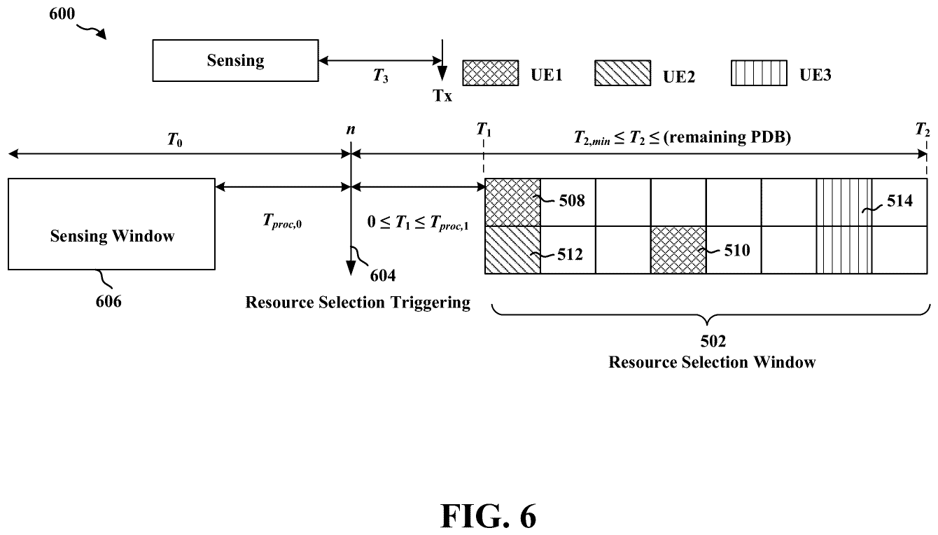

There may be a timeline for a sensing-based resource selection. FIG. 6 illustrates an example of a sensing and resource selection timeline 600. For example, the UE may sense and decode the SCI received from other UEs during a sensing window 606, e.g., a time duration prior to resource selection, e.g., triggered at 604. Based on the sensing history during the sensing window 606, the UE may be able to maintain a set of available candidate resources by excluding resources, e.g., shown for the resource selection window (at 502), that are reserved by other UEs from the set of candidate resources. A UE may select resources from its set of available candidate resources and transmits SCI reserving the selected resources for sidelink transmission (e.g., a PSSCH transmission) by the UE. There may be a time gap T₁ between the UE's selection of the resources and the UE transmitting SCI reserving the resources. The sensing window 606 may be defined by the range of slots [n−T₀, n−T_{proc,0}^{SL}), when the UE performs full sensing, where T₀ indicates the time from sensing to resource selection, and T_{proc,0}^{SL} indicates a threshold for the time period between the sensing window 606 and resource selection, e.g., at n. Aspects of the timing may be based on μ_{SL}, the SCS configuration of the SL BWP. FIG. 6 illustrates an example in which the candidate resource set may exclude resources 508, 510, 512, and 514 that will be used by other UEs, e.g., UE1, UE2, and UE3, based on SCI indicating resource reservations that the UE receives during the sensing window 606.

The UE may monitor slots that belongs to a sidelink resource pool within the sensing window 606 except for those in which its own transmissions occur.

Example aspects presented herein are related to a method for improving the efficiency of sidelink communication and reducing latency by adjusting sidelink resource sensing and selection based on the UE's FD capability. As presented herein, during a sensing window, the UE may not skip monitoring slots in which its own transmission occurs, e.g., it may perform sensing in such slots, if UE FD operation is feasible in those slots. The method may include determining the conditions under which FD operation for SL UE is feasible, such that the transmission does not negatively impact the simultaneous reception. The method improves resource utilization and overall communication efficiency by allowing the UE to transmit and receive data simultaneously without compromising the quality of the received signals.

In wireless communication, a UE may exchange sidelink communication using HD operation, in which the UE may transmit (Tx) or receive (Rx) at any given time, but not simultaneously transmit and receive. Resource selection for SL communication may be based on this HD assumption, leading a UE to select resource for either Tx or Rx operation at one time. While this approach ensures that the transmission and reception do not interfere with each other, it may reduce resource utilization, particularly when the UE has the capability to perform simultaneous Tx and Rx operations, e.g., FD communication.

In an HD resource selection and sensing procedures, the UE may either transmit or receive at a given time. During the sensing window, e.g., 606 in FIG. 6, the UE will skip monitoring slots in which its own transmissions occur, based on the HD assumption. This approach may result in the exclusion of corresponding periodic resources from the available resources in the resource selection window, even if no such periodic resource reservation actually exists. Aspects presented herein enable a more efficient and accurate sensing procedure by enabling the UE, under particular conditions, to include its transmission resources in the monitoring performed in the sensing window 606 and potentially as available resources in the resource selection window.

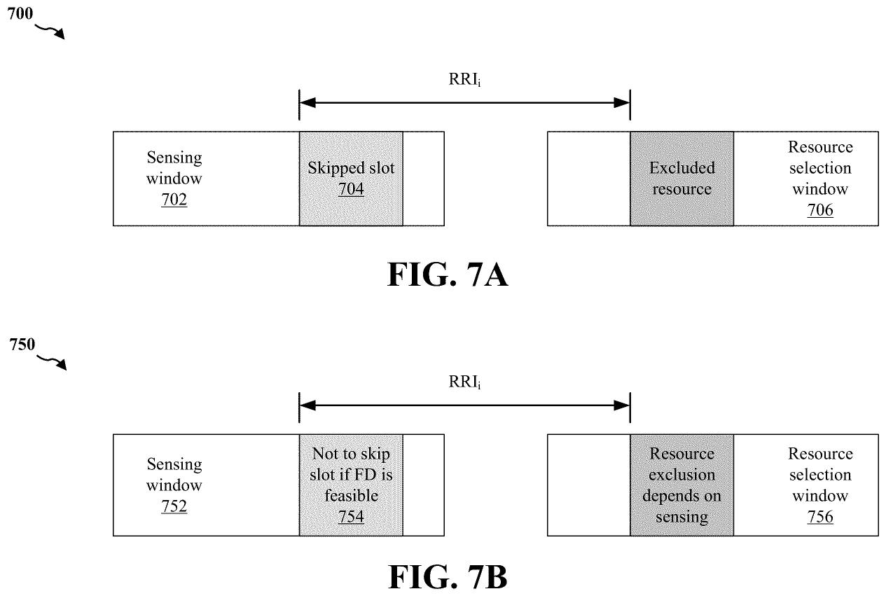

FIG. 7A is a diagram 700 illustrating an example of resource exclusion based on the HD assumption. The sensing window and resource selection window in FIG. 7A may include aspects similar to the sensing window and resource selection window described in connection with FIG. 6. In FIG. 7A, the sensing window 702 may be defined by a range of slots, and the UE may monitor slots that belong to a sidelink resource pool within this window 702, excluding those slots with its own transmissions (e.g., skipped slots 704). The UE may use the resource reservations received from other UEs during the sensing window 702 to maintain a set of candidate resources available to be selected for sidelink transmissions in a resource selection window 706. The UE's behavior is then determined based on Physical Sidelink Control Channel (PSCCH) decoding and Reference Signal Received Power (RSRP) measurements in the monitored slots. This HD-based approach may lead to less efficient resource utilization, particularly when the UE is capable of FD operation (i.e., simultaneous Tx and Rx) in those resources.

Example aspects presented herein provide an FD feasibility-aware sidelink resource selection method for UE. In some aspects, in the sensing windows, the UE will not skip monitoring slots in which its own transmissions occur if FD operation (i.e., the simultaneous transmission and reception of signals) is feasible for the UE in those slots. In this method, the corresponding periodic resources may be excluded from the available resources in the resource selection window when there is an actual periodic resource reservation, which may be based on, for example, Sidelink Control Information (SCI) decoding. Example aspects further provide detailed conditions under which FD operation in sidelink UE may be considered feasible. FIG. 7B is a diagram 750 illustrating an example of FD aware sidelink resource selection in accordance with various aspects of the present disclosure. The sensing window and resource selection window in FIG. 7B may include aspects similar to the sensing window and resource selection window described in connection with FIG. 6. The UE may use the resource reservations received from other UEs during the sensing window 752 to maintain a set of candidate resources available to be selected for sidelink transmissions in a resource selection window 756. In FIG. 7B, in the sensing window 752, the UE may not skip a sensing slot previously reserved for its own Tx (e.g., slot 754) if FD is feasible in that slot, e.g., as presented herein. Thus, the UE may monitor slots that belong to a sidelink resource pool within the sensing window 752 (e.g., 606) including slots in which its own transmissions occur. Further, depending on not identifying the presence of another transmission during sensing in slots, including slots in which its own transmissions occur, the UE may include the sensed available resources in those slots as candidate resources in the resource selection window 756.

Aspects presented herein provide various example conditions under which SL UE FD operation may be considered feasible, e.g., without causing degradation to simultaneous transmission and reception. For example, the use of the conditions relating to FD operation as a trigger to enable the UE to include its own transmission resources in a sensing window helps to ensure that the Tx does not adversely impact the Rx during FD operation.

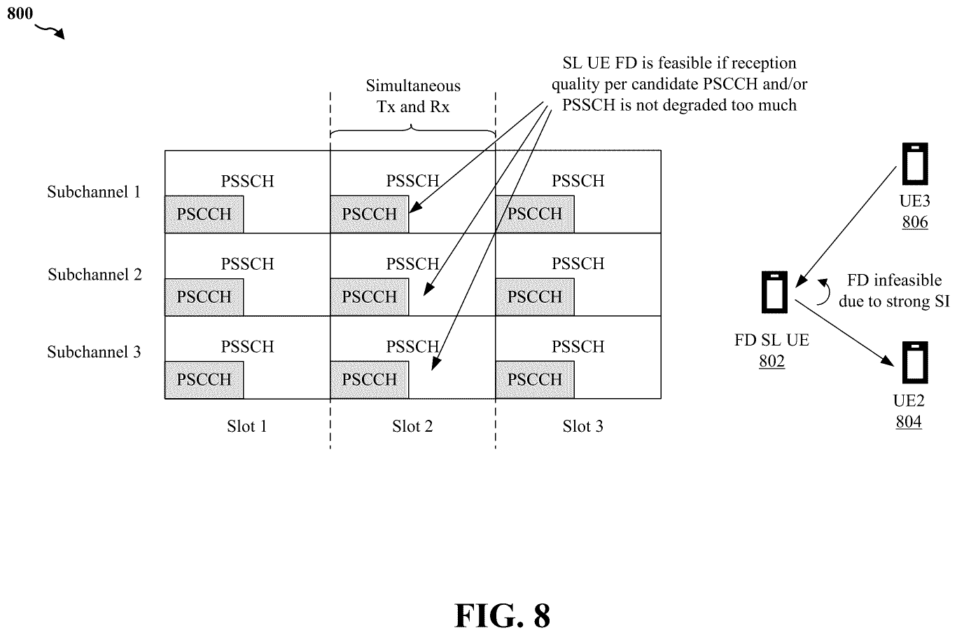

FIG. 8 is a diagram 800 illustrating an example of determining FD feasibility in accordance with various aspects of the present disclosure. In FIG. 8, an SL UE may have already reserved a slot (e.g., slot 2) for its own transmission. FD operation may be considered feasible (e.g., the condition to includes its own Tx resources when monitoring during the sensing window) when the simultaneous sensing reception quality for candidate PSCCH and/or PSSCH during the SL UE's transmission in this slot (e.g., slot 2) does not degrade by a threshold amount. The feasibility condition considers the potential degradation in FD performance due to self-interference (SI), which may be caused by factors such as the presence of a nearby dominant reflector, e.g., even if the SL UE otherwise supports FD operation. For example, in FIG. 8, for the FD-capable SL UE 802, the FD operation in a slot may be considered infeasible if there exists a threshold amount of SI when the UE 802 transmits to, for example, UE2 804 and simultaneously receives from, for example, UE3 806 at that slot.

The feasibility of SL UE FD operation may be determined based on various factors or criteria. For example, in one configuration, the feasibility of SL UE FD operation may be evaluated based on a reception quality metric during the SL UE's own transmission duration. For example, FD may be considered feasible if the reception quality metric is above a fixed, defined, or configured threshold (e.g., which may be referred to as an absolute threshold rather than a relative threshold) for all or a subset of candidate PSCCH and/or PSSCH during the SL UE's own transmission duration (e.g., when the sensing quality is not significantly affected by the SL UE's own transmission). If the reception quality metric is accessed for a subset of candidate PSCCH/PSSCH, the subset of candidate PSCCH/PSSCH may be those without a decoded channel and/or corresponding DMRS detected. In other examples, the metric may be relative to another value.

Reception quality metrics may include parameters such as RSRP, Signal-to-Interference-plus-Noise Ratio (SINR), Block Error Rate (BLER), Received Signal Strength Indicator (RSSI), total interference plus noise, and SI due to the SL UE's own transmission. In some aspects, the UE may measure one or more of these metrics during the slot that the UE is transmitting. In other aspects, the UE may predict one or more of the metrics based on past measurements in prior slots. As an example, the UE may predict the metrics using advanced techniques like artificial intelligence (AI) and machine learning (ML). Whether based on a measurement in the slot, or a prediction for the slot based on past measurements, the UE may consider FD transmission and reception feasible in the slot(s) if the metric meets the threshold for the FD condition, such as the RSRP or SINR being above a corresponding threshold, or other metrics parameters being below a corresponding threshold.

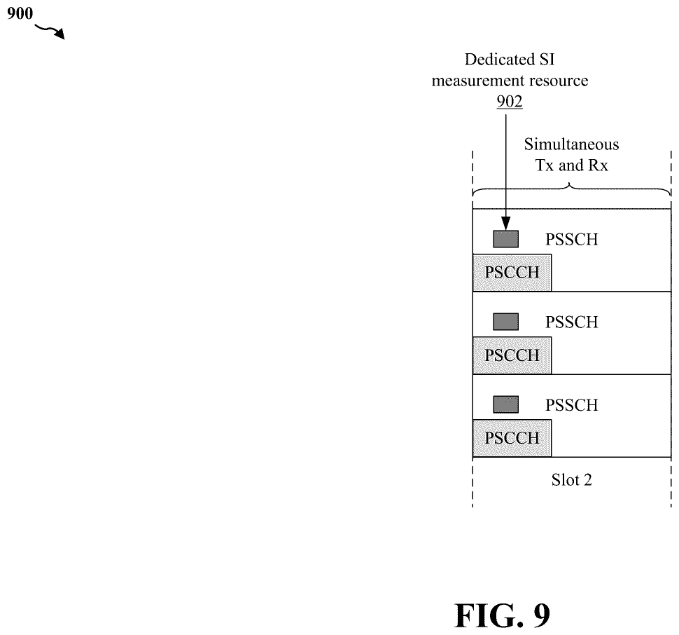

The reception quality metrics may be measured or predicted by any combination of the PSCCH/PSSCH DMRS REs, the PSCCH/PSSCH data REs, or dedicated measurement REs without PSCCH/PSSCH. For example, RSRP, SINR, BLER, and total interference plus noise may be measured over DMRS REs of a PSCCH/PSSCH that is being sensed. The DMRS provides information for the presence of a signal, while the remaining energy accounts for interference (including SI) plus noise. For example, SI may be measured on dedicated measurement REs without any transmitted signal from other users (i.e., SI plus noise will be present on those REs). FIG. 9 is a diagram 900 illustrating an example of a dedicated SI measurement resource in accordance with various aspects of the present disclosure. In FIG. 9, dedicated SI measurement resource 902 may be configured on each candidate PSCCH in a slot for SI measurement, and the UE may determine the FD feasibility, e.g., whether the condition is met for FD sensing and transmission, for FD resource selection, etc., on this slot based at least in part on the SI measurement on the dedicated SI measurement resource 902.

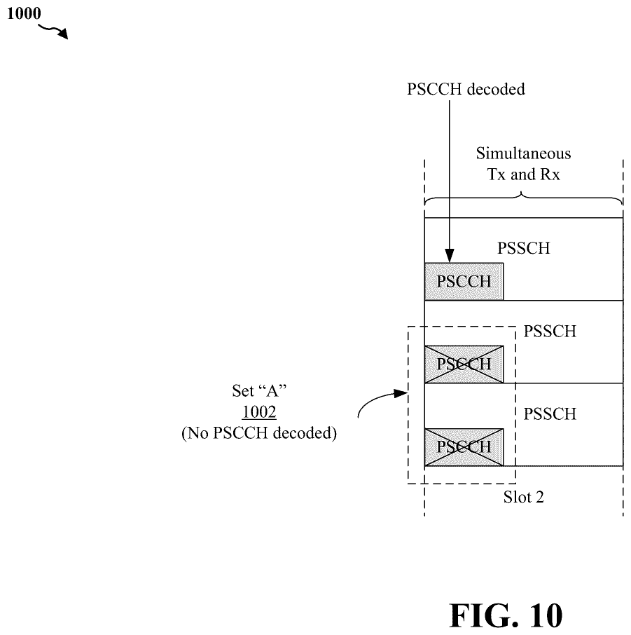

FIG. 10 is a diagram 1000 illustrating an example of determining the FD feasibility of an SL UE in accordance with various aspects of the present disclosure. In FIG. 10, the feasibility of SL UE FD operation may be determined based on the RSSI measured on candidate PSCCH. Here, a candidate PSCCH is a potential PSSCH transmitted by another UE whose presence is being sensed by the SL UE. In this example, SL UE FD sensing may be deemed infeasible if there is any candidate PSCCH detected with an RSSI value greater than a threshold but without PSCCH decoded during the SL UE transmission duration. This is because such a condition may indicate that the high RSSI may be due to SI rather than the presence of a PSSCH (which was not decoded).

In the example of FIG. 10, a set of PSCCH in a slot that includes any candidate PSCCH without SCI decoded during the transmission duration may be referred to as “set ‘A’” 1002. If set “A” 1002 is not empty and any candidate PSCCH in set “A” 1002 has DMRS detected, then SL UE FD sensing is considered infeasible, as this PSCCH is not decoded in spite of a DMRS being detected indicating the presence of high SI. If, on the other hand, there is no DMRS detected but the RSSI is greater than a threshold for any candidate PSCCH in set “A” 1002 (at least on DMRS REs), SL UE FD sensing is still deemed infeasible, as the high RSSI is likely not originating from the PSCCH but rather from SI. If neither of these conditions is met, SL UE FD sensing is considered feasible in that slot. The same applies if set “A” 1002 is empty.

This approach aims to minimize ambiguity in situations where PSCCH decoding fails due to either the absence of PSCCH or the presence of SI. In FIG. 10, candidate PSCCH/PSSCH represent those being transmitted by other UEs, which the SL UE is trying to sense. The PSCCH locations may not be decoded. In the case of no PSCCH decoding (e.g., set “A” 1002), the UE checks for DMRS detection (assuming SI caused the decoding failure) and high RSSI values (indicating SI is likely causing high RSSI in the absence of PSCCH). If neither condition is met, sensing (or other FD operation) may be considered feasible, as either PSCCH has been decoded correctly or not decoded and no SI is observed. In both cases, sensing results can be utilized, or other FD operations may be employed.

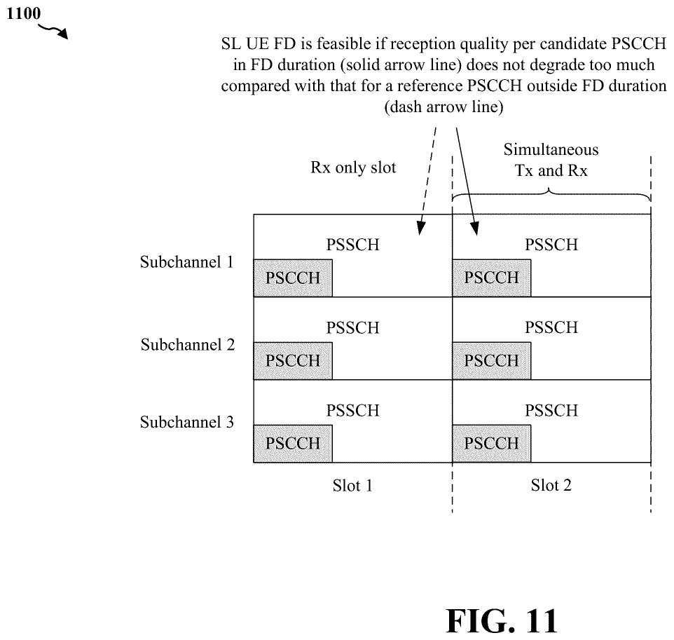

In one configuration, the feasibility of SL UE FD operation may be determined by comparing the reception quality metric for any candidate PSCCH and/or PSSCH within the SL UE's own transmission duration to a reference PSCCH and/or PSSCH outside the SL UE's transmission duration. FD operation is deemed feasible if the reception quality metric is within a relative range with that for the reference PSCCH and/or PSSCH. FIG. 11 is a diagram 1100 illustrating an example of determining the FD feasibility of an SL UE in accordance with various aspects of the present disclosure. For the purpose of FIG. 11, an FD duration may be a slot where a UE is simultaneously transmitting and receiving, where the receiving may be due to either sensing or data reception. In FIG. 11, if the total interference plus noise for a candidate PSCCH during the FD duration in a slot and a subchannel (e.g., in slot 2 and subchannel 1) does not increase by more than a threshold (e.g., X dB) compared to the corresponding reference PSCCH outside the FD duration (e.g., in slot 1 and subchannel 1), it implies that the sensing quality during the FD duration (e.g., in slot 2) is similar to that during non-FD durations (e.g., in slot 1).

In another configuration, the feasibility of SL UE FD operation may be determined based on the utilization of a specific set of transmission and reception parameters that ensure reception quality. These parameters may include the modulation and coding scheme (MCS), the number of layers, beam/TCI, transmission and reception power, transmission and reception timing, and the guard band between transmission and reception, among others. By adopting a particular combination of these parameters, the SL UE can ensure that the reception quality remains within acceptable limits during FD operation.

The FD feasibility conditions described in connection with FIGS. 8-11 may also be used for other FD operations, such as the selection of sidelink transmission resources that will also be used for sidelink reception, when FD feasibility is determined.

In some aspects, the FD feasibility performance conditions described above may be extended to cover simultaneous transmission and reception of sidelink traffic, in addition to the simultaneous sensing and transmission.

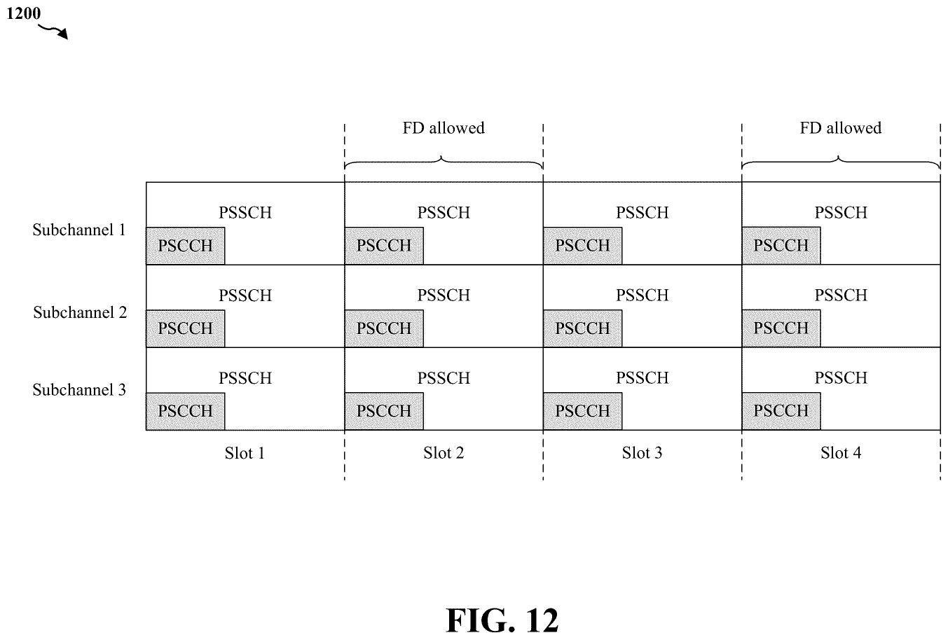

Additionally, in some examples, the SL UE may only check FD feasibility within the resources allowed for FD operation. These resources may be indicated by a fixed rule or by a network node (e.g., a base station, network entity, or a third-party node) via, for example, RRC, medium access control-control element (MAC-CE), or DCI. Such indications may help to streamline the FD feasibility assessment process and help the SL UE to focus on the appropriate resources when evaluating FD operation. FIG. 12 is a diagram 1200 illustrating an example of determining the FD feasibility within the allowed resources. In FIG. 12, for example, the RRC signaling received by the UE may specify the slots that are permitted for FD operation. These slots may be, for example, slot 2, slot 4, and so on. By receiving this information, the SL UE may concentrate its efforts on assessing the feasibility of FD operation within the allowed resources, saving power, improving the efficiency of the process and improving performance of the device during FD operation.

Example aspects presented herein further provide methods for indicating preferred resources, non-preferred resources, and conflicting resources for FD UE in the context of sidelink inter-UE coordination (IUC) messages. An IUC message is a sidelink message that can include different types of information to assist other sidelink UEs in selecting transmission resources or avoiding conflicting sidelink resources of other UEs. For example, the IUC can assist UEs in performing resource selection under Mode 2 resource allocation. In some aspects, the IUC may indicate preferred resources, e.g., resources on which sidelink reception is preferred. In some aspects, the IUC may indicate non-preferred resources, e.g., resources that the UE prefers to avoid for sidelink reception. In some aspects, the IUC may indicate that a resource conflict occurs on a first reserved resources. A UE may transmit the IUC message, based on HD operation, to exclude resources where the UE will transmit from the preferred resources for transport block (TB) reception. Additionally, the UE may include resources where this UE will transmit in an indication of non-preferred resources for TB reception, based on the assumption that the UE may perform HD operation. The UE may indicate that a resource conflict occurs on a reserved resource that occurs in a slot in which the UE does not expect to perform SL reception due to HD operation. Aspects presented herein provide for more efficient resource use and reduced latency by enabling the UE to provide IUC that includes resources in which the UE transmits and supports FD operation, e.g., based on a condition for FD operation being met.

Example aspects presented herein provide a new approach to determine preferred and non-preferred resources for a UE at least for intended TB reception, considering the FD capabilities of the UE, e.g., a condition for FD operation or FD feasibility. The FD feasibility may be based on any of the example aspects described in connection with FIGS. 8-11. In some aspects, when determining preferred resources for intended TB reception, a UE may not exclude time resources or slots, e.g., includes the time resources/slots, in which its own transmission will occur if FD operation is feasible at least within those time resources or slots. Similarly, when determining non-preferred resources for intended TB reception, a UE may not include time resources or slots, e.g., excludes time resources or slots, in which its own Tx will occur if FD operation is feasible at least within those time resources or slots.

The feasibility of the FD operation may be determined using the options described above. For example, the feasibility of the FD operation may be determined by comparing the reception quality metric with a fixed, defined, or configured threshold or reference values or by employing specific sets of transmission and reception parameters. By incorporating the FD capabilities of the UE into the preferred and non-preferred resource determination process, resource allocation and coordination for FD-capable UEs may be optimized.

Example aspects presented herein further provide methods for conflicted resource determination in the context of IUC including a consideration of an FD condition for the UE. Under an HD assumption, when a UE transmits an IUC message, it includes resources where the UE will transmit into conflicted resources for scheduled TB reception.

Example aspects presented herein provide a new approach to determine the conflicted resources for UE, e.g., for intended TB reception, considering the FD capabilities of the UE. In some aspects, when determining conflicted resources for TB reception, a UE may not include time resources or slots in which its own transmission will occur if FD operation is feasible at least in those time resources or slots. The feasibility of SL UE FD operation can be determined using the options described above, e.g., in connection with FIGS. 8-11. For example, the feasibility of FD operation may be determined by comparing the reception quality metric with a fixed, defined, or configured threshold value or reference values or by employing specific sets of transmission and reception parameters.

Furthermore, for conflicted resource determination and preferred and non-preferred resources determination for FD UE in the context of IUC, the reporting UE may provide additional information to other UEs via, for example, the IUC message or other sidelink signaling, to facilitate better resource selection for other UEs. This information may include the measured or predicted metrics of preferred, non-preferred, or conflicted resources for the reception. Example aspects presented above for determining the feasibility of SL UE FD operation may be referred to for details of the metrics and measurement resources, which are not repeatedly present herein for the sake of conciseness. The information may further include an indication of whether the preferred, non-preferred, or conflicted resources for the reception have been reserved for the reporting UE's transmission. Additionally, the reporting UE can also share its transmission priority on those resources with other UEs.

Example aspects presented herein further provide a method for FD aware SL channel prioritization for certain frequency bands, such as millimeter-wave (mmW) bands. These example aspects provide an updated channel prioritization process that considers the FD capabilities of a UE in wireless communication.

Based on HD operation, if a UE would transmit or receive a first channel/signal and transmit a second channel/signal that would overlap in time with the first channel/signal, the UE may transmit or receive the channel/signal with the highest priority. The UE may skip reception of the lower priority channel/signal.

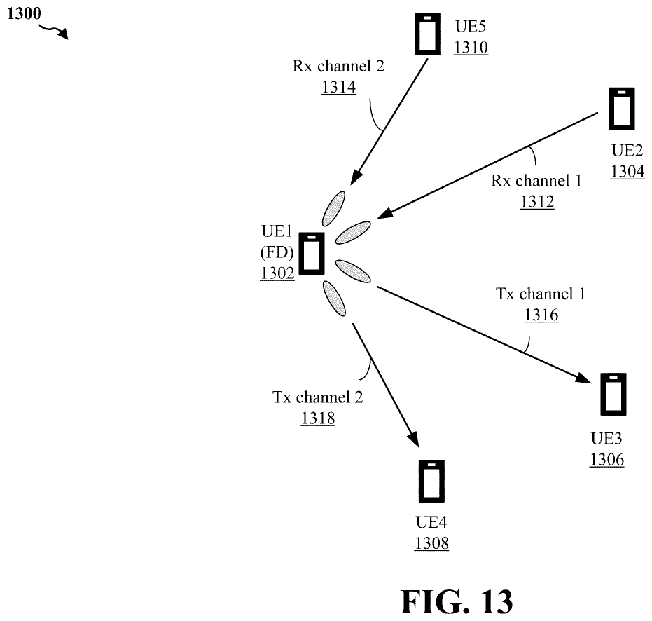

As a result, when at least one transmission channel and at least one reception channel overlapped in time at the SL UE, the UE may prioritize one channel across all those overlapped Tx and Rx channels. FIG. 13 is a diagram 1300 illustrating an example of channel prioritization under the HD assumption. In FIG. 13, UE1 1302 may receive from UE2 1304 via Rx channel 1 1312, transmit to UE3 1306 via Tx channel 1 1316, transmit to UE4 1308 via Tx channel 2 1318, and receive from UE5 1310 via Rx channel 2 1314. If one of the Rx channels (e.g., Rx channel 1 1312 or Rx channel 2 1314) overlaps with one of the Tx channels (e.g., Tx channel 1 1316 or Tx channel 2 1318), one Tx or Rx channel may be prioritized due to the HD assumption on UE1 1302.

The prioritization rule may be based on the first channel/signal being for a first radio access technology (RAT), and the second channel/signal being for a second RAT. As an example, the first RAT may be LTE, and the second RAT may be NR. In scenarios where at least one LTE channel or RS overlaps with at least one NR SL channel or RS at the SL UE with reverse transmission and reception directions, the UE may select the channel or RS from the RAT with the highest priority among all overlapped channels or RSs for either transmission or reception.

Physical Sidelink Feedback Channel (PSFCH) prioritization may also be based on anassumption that UE operates in HD mode. When at least one PSFCH overlaps with another PSFCH at the SL UE with reverse transmission and reception directions, the HD prioritization rule may select the PSFCH with the highest priority among all overlapped PSFCHs for either transmission or reception.

SL and UL channel prioritization for HD UE highlights another potential HD prioritization rule, designed on the assumption that UE operates in HD mode. When at least one SL channel or RS overlaps with at least one UL channel or RS at the SL UE with reverse transmission and reception directions, the UE may prioritize the SL or UL channel(s) or reference signal(s) (RS(s)) with the highest priority among all overlapped channels or RSs for either transmission or reception.

Aspects presented herein provide for prioritization, including a different RAT SL channel prioritization rule, a PSFCH prioritization rule, and an SL and UL channel prioritization rule for UEs that may meet FD conditions, at times, in order to improve spectral efficiency and reduce latency.

Example aspects presented herein provide a method for an FD aware SL channel prioritization, which considers the capabilities of FD UE. In some aspects, the SL channel prioritization may be for a particular frequency, such as for mmW communication. The UE may consider FD feasibility for a transmission and reception beam pair in addition to priority for a channel or signal. In some aspects, when the first set of the overlapped channel(s) or RS(s) for transmission overlaps with the second set of the overlapped channel(s) or RS(s) for the reception at the SL UE, the following prioritization strategy may be employed.

Within the first set of channels or RSs for transmission, a set “A” of channel(s) or RS(s) may be prioritized for transmission. Simultaneously, within the second set of channels or RSs for Rx, a set “B” of channel(s) or RS(s) may be prioritized for Rx. Sets “A” and “B” may be jointly selected for FD operation based on their transmission and reception beams, as well as their priorities.

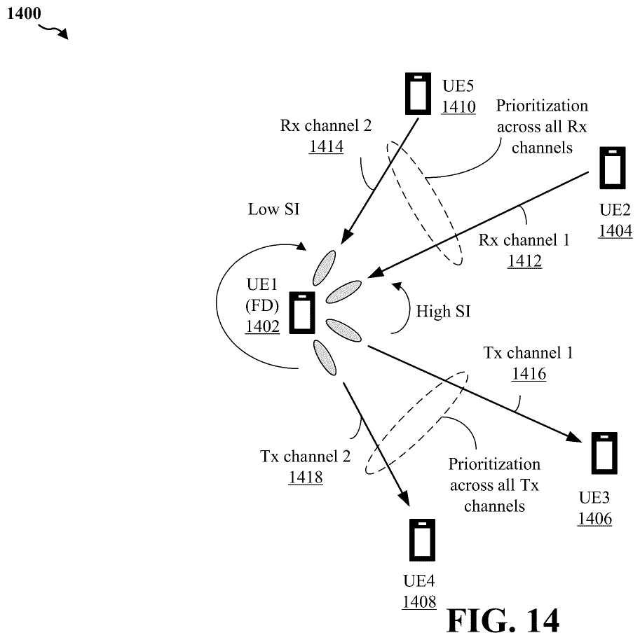

This joint selection improves the prioritization because some pairs of transmission and reception beams may allow for accurate FD communication and other pairs of beams may not be compatible for FD operation due to strong SI, which may be caused by factors such as a nearby reflector. FIG. 14 is a diagram 1400 illustrating an example of FD aware SL channel prioritization in accordance with various aspects of the present disclosure. In FIG. 14, a beam pair of Rx channel 1 1412 (from UE2 1404) and Tx channel 1 1416 (to UE3 1406) might experience stronger SI than a beam pair of Rx channel 2 1414 (from UE5 1410) and Tx channel 2 1418 (to UE4 1408), even if the beam pair of Rx channel 1 1412 and Tx channel 1 1416 have higher priorities. In FIG. 14, prioritization may be performed across all Rx channels (e.g., Rx channel 1 1412 and Rx channel 2 1414), and prioritization may be performed across all Tx channels (e.g., Tx channel 1 1416 and Tx channel 2 1418).

The joint set “A” and “B” selection for FD operation in SL channels may be determined through various options, aiming to optimize network performance and user experience.

In some aspects, among all possible combinations, the SL UE may first select the combinations with compatible Tx/Rx beams for FD, regardless of their channel priorities. Next, among those selected combinations, one combination may be finally chosen based on maximizing a per-combination priority metric. This metric may be implemented in one of the following schemes.

The first scheme is to select the minimum of P1 and P2, where P1 and P2 are the lowest channel priorities of set “A” and “B”, respectively. This scheme aims to select the combination with the least impact on low-priority channels.

The second scheme is to select the maximum of P1 and P2, where P1 and P2 are the highest channel priorities of set “A” and “B”, respectively. This scheme seeks to prioritize the combination with the highest channel priorities, ensuring that the higher-priority channels are accommodated.

The third scheme is to select the average of P1 and P2, where P1 and P2 are the average channel priorities of set “A” and “B”, respectively. This scheme balances the priorities of the channels in both sets, aiming for a more evenly distributed channel prioritization.

The final combination is selected to maximize the above per-combination priority metric, ensuring the most efficient allocation of network resources and improving overall network performance. By adopting this flexible approach to joint set “A” and “B” selection, the FD-aware SL channel prioritization may better accommodate the diverse needs of different devices and use cases in millimeter-wave communication systems.

In some aspects, in an alternative approach for selecting the optimal combination of Tx and Rx beams in an FD SL channel prioritization, the SL UE may first sort all possible combinations based on a per-combination metric, regardless of whether the beams are compatible or not. Then, the UE may sequentially check for the corresponding FD beam compatibility, and the combination with the highest per-combination metric and FD beam compatibility is finally selected.

The per-combination priority metric may be implemented in the same three schemes described above, allowing for a flexible approach in optimizing network performance. In one example, the per-combination priority metric may be implemented using the third scheme described above (i.e., selecting the average of P1, P2, with P1 and P2 as the average channel priority of set “A” and “B”, respectively), the final combination can be selected using the following procedure:

The SL UE may first fix the set “A” with the highest priority among all candidate set “A” and check if this set “A” can pair with the set “B” with the highest priority among all candidate set “B,” which provides the highest average priority.

If the corresponding beams are not compatible, the SL UE then checks if this set “A” can pair with the set “B” with the second highest priority among all candidate set “B,” and so on and so forth.

If all set “B” has been tested but is still not compatible with this set “A,” the UE moves to set “A” with the second highest priority and repeats the above procedure until a combination with compatible beams is found.

This example sequential approach enables the SL UE to efficiently search for the best combination of transmission and reception beams that maximize the per-combination priority metric while ensuring FD beam compatibility. This enhances network performance and user experience in millimeter-wave communication systems.

In some aspects, the first and second sets of channels/RSs at the SL UE may have various combinations, such as belonging to different RATs (e.g., LTE and NR), belonging to the same type of channel/RS but with different directions (e.g., PSFCH for transmission and for reception), or belonging to different link types (e.g., UL/DL in comparison to SL).

In some aspects, the priority per Tx/Rx channel/RS may be determined from control information for the sidelink transmission, such as a resource reservation. For example. the priority could be determined by the SCI/DCI/MAC-CE scheduling/activating the Tx/Rx, provided by RRC or by fixed rules in the specification for periodic channels/RSs, such as SSB in Uu or SL, and PSFCH/PUCCH not carrying HARQ ACK info, carrying CSI info. Additionally, the priority could be the same as the associated Tx/Rx, where PSFCH/PUCCH carrying HARQ ACK info would have the same priority as the corresponding PSSCH/PDSCH carrying the traffic.

In some aspects, signaling/rule may be specified to align on which prioritization rule to use between the UE performing the prioritization and other nodes associated with the Rx/Tx channels/RSs to be prioritized. The prioritization rules may include the HD rule (e.g., assuming the UE may either transmit or receive) and the proposed FD rule (e.g., assuming the UE may transmit and receive simultaneously). The other nodes may at least include SL UEs (e.g., when all prioritized channels are SL) and base stations (e.g., when prioritized channels include Uu and SL).

Several options for signaling or rule alignment have been proposed.

In some examples, the FD prioritization rule may be used for the time resources where FD is allowed, e.g., FD slots/symbols configured or indicated by the base station, third-party node, or specification.

In some examples, the base station, third-party node, or specification may transmit an indication of the time resources where the FD prioritization rule is to be used.

In some examples, the UE performing the prioritization may transmit an indication or recommendation of the time resources for using the FD prioritization rule, based on FD feasibility measurements or predictions.

In some examples, the proposed FD transmission and reception prioritization rule may cause inconsistency if one UE prepares for Tx and Rx while another node expects the HD rule to apply. To address this potential issue, the UE performing prioritization may inform other nodes about the rule being used, e.g., whether an HD rule or an FD rule is used. Furthermore, an additional option could be for the UE to indicate the selected transmission and reception links to other nodes whenever the FD rule is selected. This would provide the added benefit of allowing other UEs to either forgo their transmission or enter sleep mode if they are not selected for transmission or reception. This approach provides better coordination and efficiency within the network, leading to improved network performance and user experience.

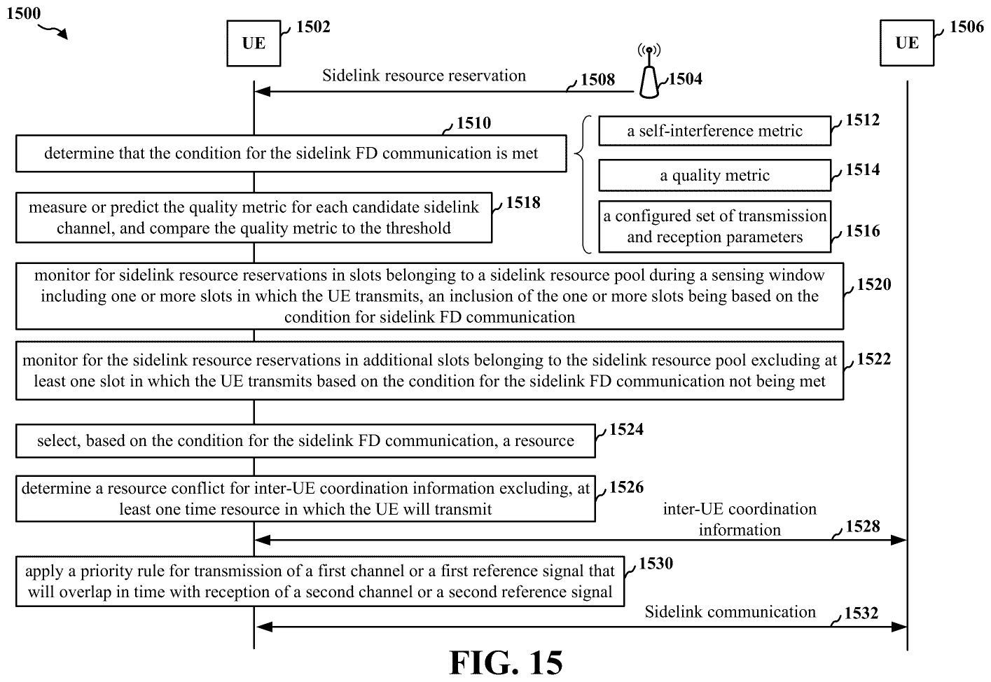

FIG. 15 is a call flow diagram 1500 illustrating a method of wireless communication in accordance with various aspects of this present disclosure. Example aspects are described in connection with the UE 1502, the UE 1506, and the base station 1504. Various aspects may be performed by a UE or a base station in aggregation and/or by one or more components of a base station 1504 (e.g., such as a CU 110, a DU 130, and/or an RU 140).

As shown in FIG. 15, the UE 1502 may, at 1508, receive sidelink resource reservation from base station 1504.

At 1510, the UE 1502 may determine that the condition for the sidelink FD communication is met. In some aspects, the condition for sidelink FD communication may be determined based on one or more of a self-interference metric (1512), a quality metric (1514), and a configured set of transmission and reception parameters (1516). In some aspects, the configured set of transmission and reception parameters (1516) for the condition for the sidelink FD communication may include one or more of: the MCS, the number of layers, the TCI state, the transmission and reception power, the transmission and reception timing, or the guard band in frequency between transmission and reception. Example aspects of determining an FD feasibility are described in connection with FIGS. 8-11.

At 1518, the UE 1502 may measure the quality metric for each candidate sidelink channel during the one or more slots in which the UE transmits or predicts the quality metric for each candidate sidelink channel based on one or more past measurements; and compare the quality metric to the threshold to determine if the condition for the sidelink FD communication is met. The quality metric may include at least one of: the RSRP, the SINR, the BLER, the RSSI, a total interference plus noise, or a self-interference measurement. For example, referring to FIG. 11, the UE may measure the quality metric for each candidate sidelink channel (e.g., slot 2) during the one or more slots in which the UE transmits, and compare the quality metric to the threshold to determine if the condition for the sidelink FD communication is met.

At 1520, the UE 1502 may monitor for sidelink resource reservations in slots belonging to a sidelink resource pool during a sensing window including one or more slots in which the UE transmits. The inclusion of the one or more slots may be based on the condition for sidelink FD communication. For example, referring to FIG. 8, a UE may monitor for sidelink resource reservations in slots (e.g., slots 1-3) belonging to a sidelink resource pool during a sensing window including one or more slots (e.g., slot 2) in which the UE transmits, and the inclusion of the one or more slots may be based on the condition for sidelink FD communication.

In some aspects, at 1522, the UE 1502 may monitor for the sidelink resource reservations in additional slots belonging to the sidelink resource pool excluding at least one slot in which the UE transmits based on the condition for the sidelink FD communication not being met.

At 1524, the UE 1502 may select, based on the condition for the sidelink FD communication, a resource. In some aspects, the resource may be a reception resource for receiving sidelink communication overlapping in time with the resource in which the sidelink transmission is transmitted. In some aspects, the resource may be for the sidelink transmission that overlaps in time with scheduled resources for the reception of sidelink communication. For example, referring to FIG. 11, the UE may select, based on the condition for the sidelink FD communication, a resource (slot 2). The resource may be a reception resource for receiving sidelink communication or a transmission resource for transmitting sidelink communication.

At 1526, the UE 1502 may determine a resource conflict for inter-UE coordination information excluding, at least one time resource in which the UE will transmit.

At 1528, the UE 1502 may transmit inter-UE coordination information based on the condition for the sidelink FD communication to another UE (e.g., UE 1506). The inter-UE coordination information may indicate at least one of a preferred resource set, a non-preferred resource set, or a resource conflict indication, and may further indicate one or more of: the condition for the sidelink FD communication, the measurement associated with the condition for the sidelink FD communication, at least one selected resource for transmission by the UE, or a priority of the transmission by the UE

At 1530, the UE 1502 may apply a priority rule for transmission of a first channel or a first reference signal that will overlap in time with the reception of a second channel or a second reference signal.

At 1532, the UE 1502 may transmit to, or receive from, another UE (e.g., UE 1506) sidelink communication. For example, referring to FIG. 11, the UE may transmit to, or receive from, another UE sidelink communication using the selected resources (e.g., slot 2).

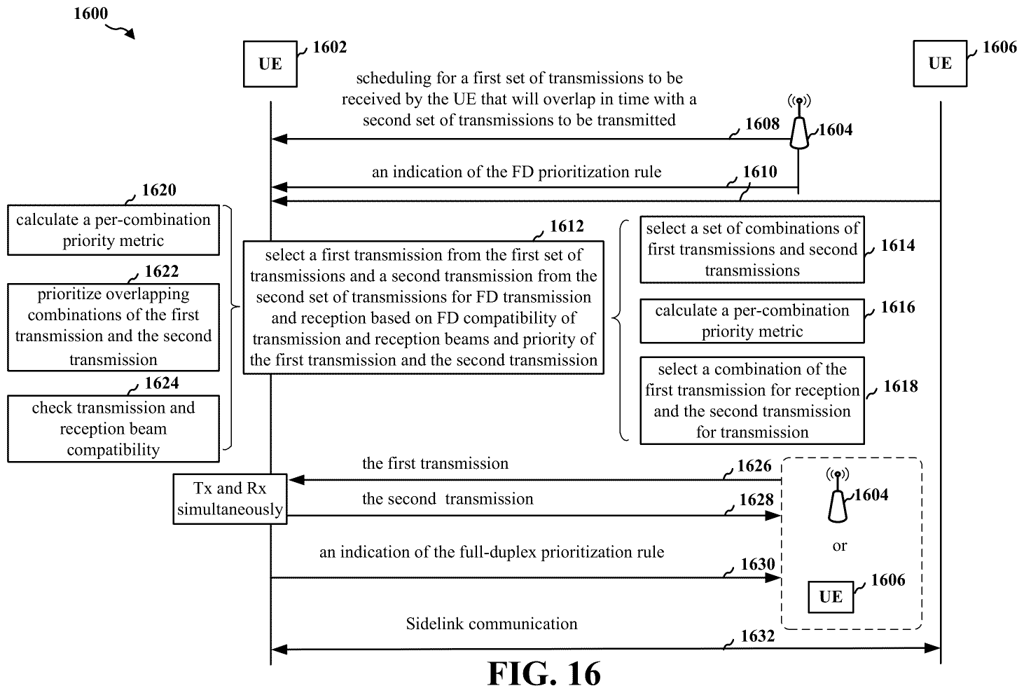

FIG. 16 is a call flow diagram 1600 illustrating a method of wireless communication in accordance with various aspects of this present disclosure. Example aspects are described in connection with the UE 1602, the UE 1606, and the base station 1604. Various aspects may be performed by a UE or a base station in aggregation and/or by one or more components of a base station 1504 (e.g., such as a CU 110, a DU 130, and/or an RU 140).

As shown in FIG. 16, the UE 1602 may, at 1608, receive scheduling for a first set of transmissions to be received by the UE that will overlap in time with a second set of transmissions to be transmitted. In some aspects, the UE 1602 may receive the scheduling from, for example, the base station 1604.

At 1610, the UE 1602 may receive an indication of the FD prioritization rule. UE 1602 may receive the indication from the base station 1604 or the UE 1606.

At 1612, the UE 1602 may select a first transmission from the first set of transmissions and a second transmission from the second set of transmissions for FD transmission and reception based on FD compatibility of transmission and reception beams and priority of the first transmission and the second transmission.

In some aspects, to select the first transmission and the second transmission at 1612, the UE 1602 may, at 1614, select a set of combinations of first transmissions and second transmissions. Each combination may have a transmission beam and reception beam pair that support the FD transmission and reception. UE 1602 may further calculate, at 1616, a per-combination priority metric based on the priority of the first transmission and the second transmission and, at 1618, select a combination of the first transmission for reception and the second transmission for transmission from the set of combinations, based on maximizing the per-combination priority metric.

In some aspects, to select the first transmission and the second transmission at 1612, the UE 1602 may calculate, at 1620, a per-combination priority metric based on the priority of the first transmission and the second transmission and prioritize, at 1622, overlapping combinations of the first transmission for reception and the second transmission for transmission based on a per combination priority metric. The UE 1602 may further, at 1624, check transmission and reception beam compatibility for the overlapping combinations in descending order of the per-combination priority metric until a threshold number of combinations are determined to have a set of transmission and reception beams that support the FD transmission and reception.

The UE 1602 may receive, at 1626, the first transmission while transmitting, at 1628 the second transmission based on FD operation. The UE 1602 may receive the first transmission from another UE (e.g., UE 1606) or a base station (e.g., base station 1604). The UE 1602 may transmit the second transmission to another UE (e.g., UE 1606) or a base station (e.g., base station 1604).

At 1630, the UE 1602 may transmit an indication of the FD prioritization rule applied by the UE 1602. The UE 1602 may transmit an indication of the FD prioritization rule to another UE (e.g., UE 1606) or a base station (e.g., base station 1604). At 1632, the UE 1602 may exchange sidelink communication after applying the prioritization rule. For example, the UE 1602 may transmit and receive communication that has a transmission and reception beam pairing that supports FD communication and has a higher priority.

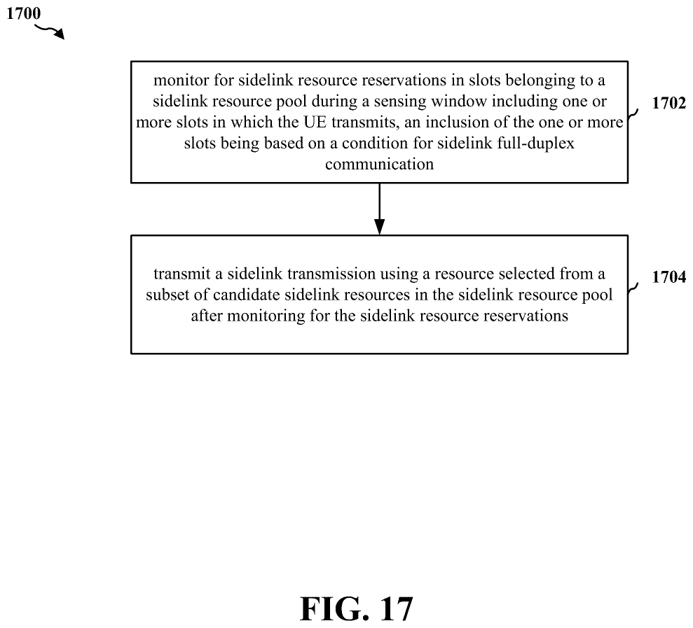

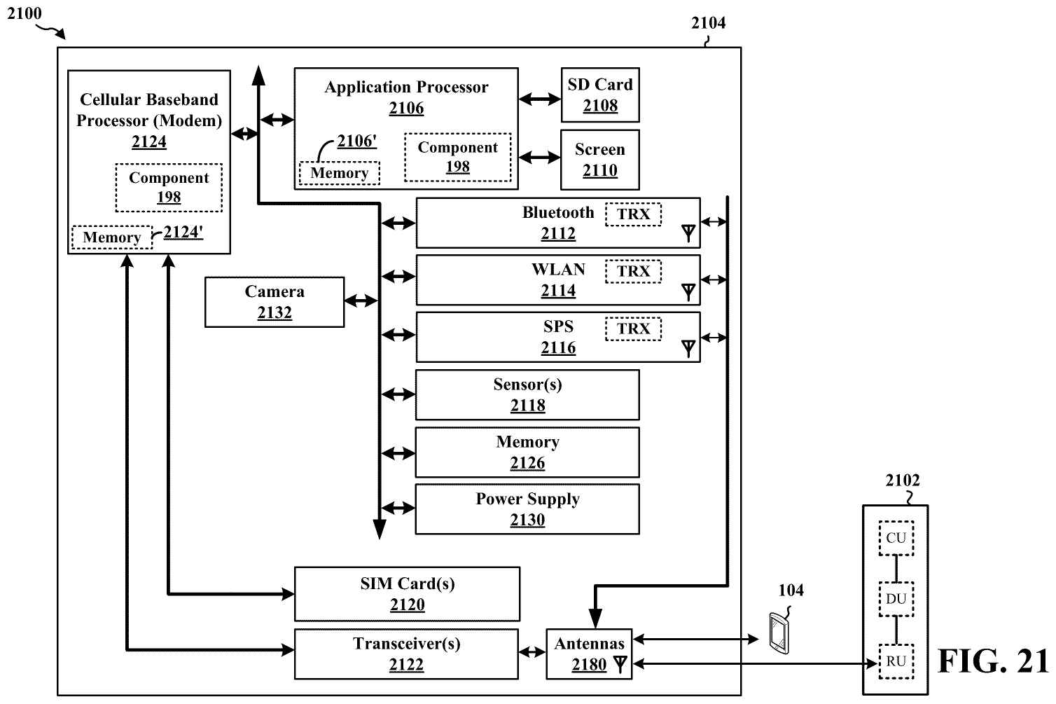

FIG. 17 is a flowchart 1700 illustrating methods of wireless communication at a UE in accordance with various aspects of the present disclosure. The method may be performed by a UE. The UE may be the UE 104, 802, 1402, 1502, 1602, device 350, or the apparatus 2104 in the hardware implementation of FIG. 21. The method improves the efficiency and performance of SL communication by enabling FD operation and facilitating better resource selection and channel prioritization.

As shown in FIG. 17, at 1702, the UE may monitor for sidelink resource reservations in slots belonging to a sidelink resource pool during a sensing window including one or more slots in which the UE transmits. The inclusion of the one or more slots may be based on a condition for sidelink FD communication. FIGS. 8, 9, 10, 11, 12, 14, 15, and 16 illustrate various aspects of the steps in connection with flowchart 1700. For example, referring to FIG. 15, the UE 1502 may, at 1520, monitor for sidelink resource reservations in slots belonging to a sidelink resource pool during a sensing window including one or more slots in which the UE 1502 transmits. The inclusion of the one or more slots may be based on the condition for sidelink FD communication. Referring to FIG. 8, the slots (slots 1-3) may belong to a sidelink resource pool during a sensing window including one or more slots (e.g., slot 2) in which the UE transmits. In some aspects, 1702 may be performed by the SL resource selection component 198.

At 1704, the UE may transmit a sidelink transmission using a resource selected from a subset of candidate sidelink resources in the sidelink resource pool after monitoring for the sidelink resource reservations. For example, referring to FIG. 15, the UE 1502 may transmit, at 1528, a sidelink transmission using a resource selected from a subset of candidate sidelink resources in the sidelink resource pool after monitoring for the sidelink resource reservations (at 1520). In some aspects, 1704 may be performed by the SL resource selection component 198.

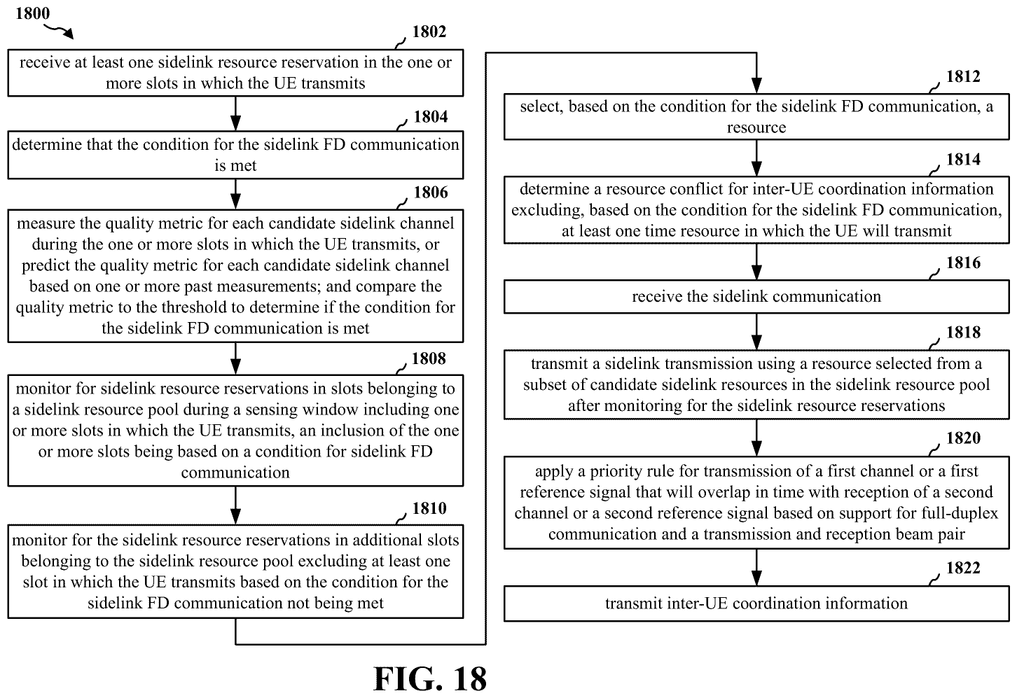

FIG. 18 is a flowchart 1800 illustrating methods of wireless communication at a UE in accordance with various aspects of the present disclosure. The method may be performed by a UE. The UE may be the UE 104, 802, 1402, 1502, 1602, device 350, or the apparatus 2104 in the hardware implementation of FIG. 21. The method improves the efficiency and performance of SL communication by enabling FD operation and facilitating better resource selection and channel prioritization.

As shown in FIG. 18, at 1808, the UE may monitor for sidelink resource reservations in slots belonging to a sidelink resource pool during a sensing window including one or more slots in which the UE transmits. The inclusion of the one or more slots may be based on a condition for sidelink FD communication. FIGS. 8, 9, 10, 11, 12, 14, 15, and 16 illustrate various aspects of the steps in connection with flowchart 1800. For example, referring to FIG. 15, the UE 1502 may, at 1520, monitor for sidelink resource reservations in slots belonging to a sidelink resource pool during a sensing window including one or more slots in which the UE 1502 transmits. The inclusion of the one or more slots may be based on the condition for sidelink FD communication. Referring to FIG. 8, the slots (slots 1-3) may belong to a sidelink resource pool during a sensing window including one or more slots (e.g., slot 2) in which the UE transmits. In some aspects, 1808 may be performed by the SL resource selection component 198.

At 1818, the UE may transmit a sidelink transmission using a resource selected from a subset of candidate sidelink resources in the sidelink resource pool after monitoring for the sidelink resource reservations. For example, referring to FIG. 15, the UE 1502 may transmit, at 1528, a sidelink transmission using a resource selected from a subset of candidate sidelink resources in the sidelink resource pool after monitoring for the sidelink resource reservations (at 1520). In some aspects, 1818 may be performed by the SL resource selection component 198.

At 1804, the UE may determine that the condition for the sidelink FD communication is met. The UE may monitor for the sidelink resource reservations during the one or more slots in which the UE transmits based on the condition for the sidelink FD communication being met. For example, referring to FIG. 15, the UE 1502 may determine, at 1510, that the condition for the sidelink FD communication is met. In some aspects, 1804 may be performed by SL resource selection component 198.

At 1810, the UE may monitor for the sidelink resource reservations in additional slots belonging to the sidelink resource pool excluding at least one slot in which the UE transmits based on the condition for the sidelink FD communication not being met. For example, referring to FIG. 15, the UE may, at 1522, monitor for the sidelink resource reservations in additional slots belonging to the sidelink resource pool excluding at least one slot in which the UE transmits based on the condition for the sidelink FD communication not being met. In some aspects, 1810 may be performed by SL resource selection component 198.

At 1802, the UE may receive at least one sidelink resource reservation in the one or more slots in which the UE transmits. In some aspects, the UE may receive the sidelink resource reservation from another UE reserving resources for sidelink transmission. For example, referring to FIG. 15, the UE 1502 may receive, at 1508, at least one sidelink resource reservation in the one or more slots in which the UE transmits. The UE 1502 may receive the sidelink resource reservation from, for example, base station 1504. In some aspects, 1802 may be performed by SL resource selection component 198.

In some aspects, the condition for the sidelink FD communication may include an SI metric. For example, referring to FIG. 15, the condition for the sidelink FD communication may be based on an SI metric (at 1512). Referring to FIG. 9, in some aspects, the SI metric may be measured based on the dedicated SI measurement resource 902.

In some aspects, the condition for the sidelink FD communication may include a quality metric for at least a subset of candidate sidelink channels meeting a threshold during measurement resources. For example, referring to FIG. 15, the condition for the sidelink FD communication may include a quality metric (1514) for at least a subset of candidate sidelink channels meeting a threshold during measurement resources.

In some aspects, the threshold may be a defined or configured value. For example, referring to FIG. 15, the threshold for the quality metric (1514) may be a defined or configured value.

In some aspects, the threshold may be based on a reference channel during a time period that the UE does not transmit. For example, referring to FIG. 15, the threshold for the quality metric (1514) may be based on a reference channel during a time period that the UE does not transmit. Referring to FIG. 11, the quality metric may be based on a reference channel (e.g., slot 1) during a time period that the UE does not transmit.

In some aspects, at 1806, the UE may measure the quality metric for each candidate sidelink channel during the one or more slots in which the UE transmits or predicts the quality metric for each candidate sidelink channel based on one or more past measurements; and compare the quality metric to the threshold to determine if the condition for the sidelink FD communication is met. The quality metric may include at least one of: the RSRP, the SINR, the BLER, the RSSI, the total interference plus noise, or a SI measurement. For example, referring to FIG. 15, the UE 1502 may, at 1518, measure or predict the quality metric for each candidate sidelink channel, and compare the quality metric to the threshold. In some aspects, 1806 may be performed by SL resource selection component 198.

In some aspects, the condition for the sidelink FD communication may be based on a configured set of transmission and reception parameters for the UE. For example, referring to FIG. 15, the condition for the sidelink FD communication (at 1510) may be based on a configured set of transmission and reception parameters (1516) for the UE 1502.

In some aspects, the configured set of transmission and reception parameters for the condition for the sidelink FD communication may include one or more of: the MCS, the number of layers, the TCI state, the transmission and reception power, the transmission and reception timing, or the guard band in frequency between transmission and reception. For example, referring to FIG. 15, the configured set of transmission and reception parameters (1516) for the condition for the sidelink FD communication may include one or more of: the MCS, the number of layers, the TCI state, the transmission and reception power, the transmission and reception timing, or the guard band in frequency between transmission and reception.

At 1812, the UE may select, based on the condition for the sidelink FD communication, a resource. In some aspects, the resource may be a reception resource for receiving sidelink communication overlapping in time with the resource in which the sidelink transmission is transmitted. At 1816, the UE may receive the sidelink communication in the reception resource that overlaps in time with the resource in which the sidelink transmission is transmitted. In some aspects, the resource the UE selected at 1812 may be for the sidelink transmission that overlaps in time with scheduled resources for the reception of sidelink communication. For example, referring to FIG. 15, the UE 1502 may select, at 1524, based on the condition for the sidelink FD communication (determined at 1510), a resource. The resource may be a reception resource for receiving sidelink communication overlapping in time with the resource in which the sidelink transmission is transmitted. The UE 1502 may further receive, at 1528, the sidelink communication in the reception resource that overlaps in time with the resource in which the sidelink transmission is transmitted. In some aspects, the resource the UE 1502 selected at 1524 may be for the sidelink transmission (at 1528) that overlaps in time with scheduled resources for the reception of sidelink communication. In some aspects, 1812 and 1816 may be performed by SL resource selection component 198.

In some aspects, the condition for the sidelink FD communication may be based, at least in part, on a subset of resources defined, configured, or otherwise indicated as being allowed for the sidelink FD communication. For example, referring to FIG. 12. the condition for the sidelink FD communication may be based on a subset of resources allowed for the sidelink FD communication (slots 2 and 4, which are slots allowed for sidelink FD communication).

At 1822, the UE may transmit inter-UE coordination information. In some aspects, the inter-UE coordination information may indicate a preferred resource set that includes, based on the condition for the sidelink FD communication, at least one time resource in which the UE will transmit. In some aspects, the inter-UE coordination may indicate a non-preferred resource set that excludes, based on the condition for the sidelink FD communication, at least one time resource in which the UE will transmit. For example, referring to FIG. 15, the UE 1502 may transmit, at 1532, inter-UE coordination information. In some aspects, the inter-UE coordination information may indicate a preferred resource set that includes, based on the condition for the sidelink FD communication (determined at 1510), at least one time resource in which the UE 1502 will transmit. In some aspects, the inter-UE coordination may indicate a non-preferred resource set that excludes, based on the condition for the sidelink FD communication (determined at 1510), at least one time resource in which the UE 1502 will transmit. In some aspects, 1822 may be performed by SL resource selection component 198.

At 1814, the UE may determine a resource conflict for inter-UE coordination information excluding, based on the condition for the sidelink FD communication, at least one time resource in which the UE will transmit. For example, referring to FIG. 15, the UE 1502 may determine, at 1526, a resource conflict for inter-UE coordination information excluding, based on the condition for the sidelink FD communication (determined at 1510), at least one time resource in which the UE 1502 will transmit. In some aspects, 1814 may be performed by SL resource selection component 198.

In some aspects, the inter-UE coordination information may be based on the condition for the sidelink FD communication. The inter-UE coordination information may indicate at least one of a preferred resource set, a non-preferred resource set, or a resource conflict indication, and may further indicate one or more of: the condition for the sidelink FD communication, the measurement associated with the condition for the sidelink FD communication, at least one selected resource for transmission by the UE, or the priority of the transmission by the UE. For example, referring to FIG. 15, the inter-UE coordination information (at 1532) may be based on the condition for the sidelink FD communication (determined at 1510). The inter-UE coordination information may indicate at least one of a preferred resource set, a non-preferred resource set, or a resource conflict indication. The inter-UE coordination information may further indicate one or more of: the condition for the sidelink FD communication, the measurement associated with the condition for the sidelink FD communication, at least one selected resource for transmission by the UE 1502, or the priority of the transmission by the UE 1502.

At 1820, the UE may apply a priority rule for transmission of a first channel or a first reference signal that will overlap in time with the reception of a second channel or a second reference signal based on support for FD communication and a transmission and reception beam pair. For example, referring to FIG. 15, the UE 1502 may apply, at 1530, a priority rule for transmission of a first channel or a first reference signal that will overlap in time with the reception of a second channel or a second reference signal. The priority rule may be based on support for FD communication and a transmission and reception beam pair. In some aspects, 1820 may be performed by SL resource selection component 198.

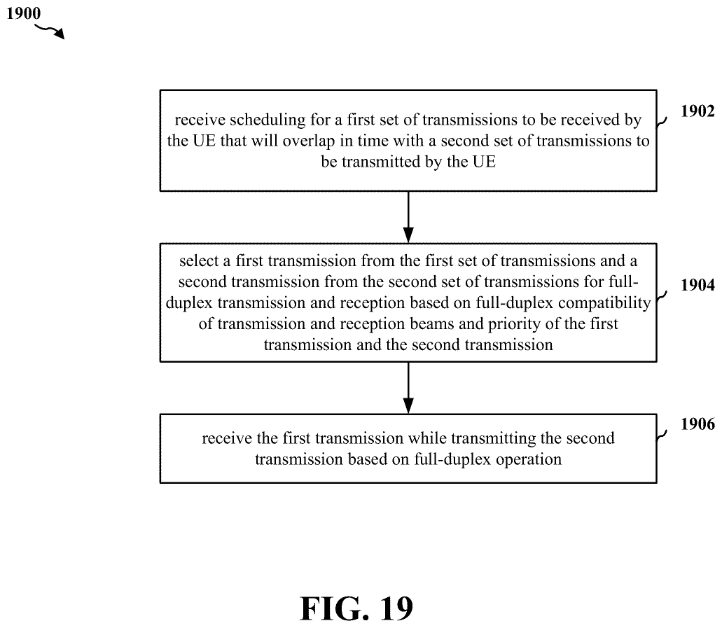

FIG. 19 is a flowchart 1900 illustrating methods of wireless communication at a UE in accordance with various aspects of the present disclosure. The method may be performed by a UE. The UE may be the UE 104, 802, 1402, 1502, 1602, device 350, or the apparatus 2104 in the hardware implementation of FIG. 21. The method improves the efficiency and performance of SL communication by enabling FD operation and facilitating better resource selection and channel prioritization.

As shown in FIG. 19, at 1902, the UE may receive scheduling for a first set of transmissions to be received by the UE that will overlap in time with a second set of transmissions to be transmitted by the UE. FIGS. 8, 9, 10, 11, 12, 14, 15, and 16 illustrate various aspects of the steps in connection with flowchart 1900. For example, referring to FIG. 16, the UE 1602 may receive, at 1608, scheduling for a first set of transmissions to be received by the UE 1602 that will overlap in time with a second set of transmissions to be transmitted by UE 1602. In some aspects, the UE 1602 may receive the scheduling from base station 1604. In some aspects, 1902 may be performed by SL resource selection component 198.

At 1904, the UE may select a first transmission from the first set of transmissions and a second transmission from the second set of transmissions for FD transmission and reception based on FD compatibility of transmission and reception beams and priority of the first transmission and the second transmission. For example, referring to FIG. 16, the UE 1602 may select, at 1612, a first transmission from the first set of transmissions and a second transmission from the second set of transmissions for FD transmission and reception based on FD compatibility of transmission and reception beams and priority of the first transmission and the second transmission. In some aspects, 1904 may be performed by SL resource selection component 198.

At 1906, the UE may receive the first transmission while transmitting the second transmission based on FD operation. For example, referring to FIG. 16, UE 1602 may receive, at 1626, the first transmission while transmitting, at 1628, the second transmission based on FD operation. UE 1602 may receive the first transmission from another UE (e.g., UE 1606) or a base station (e.g., base station 1604). UE 1602 may transmit the second transmission to another UE (e.g., UE 1606) or a base station (e.g., base station 1604). In some aspects, 1906 may be performed by SL resource selection component 198.

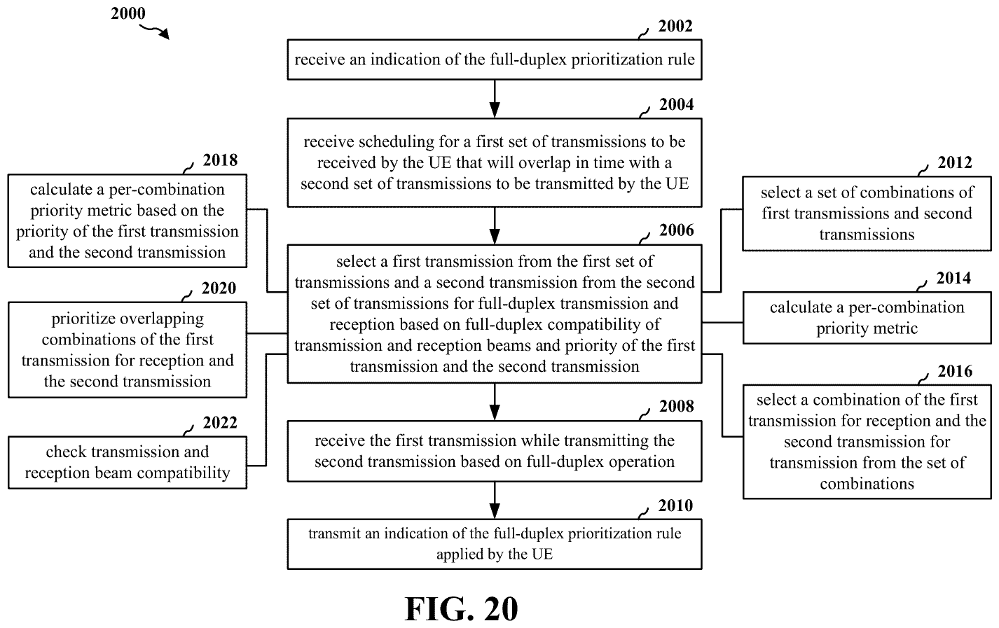

FIG. 20 is a flowchart 2000 illustrating methods of wireless communication at a UE in accordance with various aspects of the present disclosure. The method may be performed by a UE. The UE may be the UE 104, 802, 1402, 1502, 1602, device 350, or the apparatus 2104 in the hardware implementation of FIG. 21. The method improves the efficiency and performance of SL communication by enabling FD operation and facilitating better resource selection and channel prioritization.

As shown in FIG. 20, at 2004, the UE may receive scheduling for a first set of transmissions to be received by the UE that will overlap in time with a second set of transmissions to be transmitted by the UE. FIGS. 8, 9, 10, 11, 12, 14, 15, and 16 illustrate various aspects of the steps in connection with flowchart 2000. For example, referring to FIG. 16, the UE 1602 may receive, at 1608, scheduling for a first set of transmissions to be received by the UE 1602 that will overlap in time with a second set of transmissions to be transmitted by the UE 1602. In some aspects, the UE 1602 may receive the scheduling from base station 1604. In some aspects, 2004 may be performed by SL resource selection component 198.

At 2006, the UE may select a first transmission from the first set of transmissions and a second transmission from the second set of transmissions for FD transmission and reception based on FD compatibility of transmission and reception beams and priority of the first transmission and the second transmission. For example, referring to FIG. 16, the UE 1602 may select, at 1612, a first transmission from the first set of transmissions and a second transmission from the second set of transmissions for FD transmission and reception based on FD compatibility of transmission and reception beams and priority of the first transmission and the second transmission. In some aspects, 2006 may be performed by SL resource selection component 198.

At 2008, the UE may receive the first transmission while transmitting the second transmission based on FD operation. For example, referring to FIG. 16, the UE 1602 may receive, at 1626, the first transmission while transmitting, at 1628, the second transmission based on FD operation. The UE 1602 may receive the first transmission from another UE (e.g., UE 1606) or a base station (e.g., base station 1604). The UE 1602 may transmit the second transmission to another UE (e.g., UE 1606) or a base station (e.g., base station 1604). In some aspects, 2008 may be performed by SL resource selection component 198.

In some aspects, the first set of transmissions to be received by the UE may include at least one first sidelink channel or first reference signal and the second set of transmissions to be transmitted by the UE may include at least one second sidelink channel or second reference signal. For example, referring to FIG. 16, the first set of transmissions to be received by the UE 1602 may include at least one first sidelink channel (e.g., sidelink channel between the UE 1602 and the UE 1606) or first reference signal and the second set of transmissions to be transmitted by the UE 1602 may include at least one second sidelink channel (e.g., sidelink channel between the UE 1602 and the UE 1606) or second reference signal.

In some aspects, to select the first transmission from the first set of transmissions and the second transmission from the second set of transmissions for the FD transmission and reception at 2006, the UE may be configured to: select, at 2012, a set of combinations of first transmissions and second transmissions, where cach combination has a transmission beam and reception beam pair that support the FD transmission and reception; calculate, at 2014, a per-combination priority metric based on the priority of the first transmission and the second transmission; and select, at 2016, a combination of the first transmission for reception and the second transmission for transmission from the set of combinations, based on maximizing the per-combination priority metric. For example, referring to FIG. 16, to select the first transmission and the second transmission at 1612, the UE 1602 may be configured to: select, at 1614, a set of combinations of first transmissions and second transmissions. Each combination may have a transmission beam and reception beam pair that support the FD transmission and reception. The UE 1602 may be further configured to calculate, at 1616, a per-combination priority metric based on the priority of the first transmission and the second transmission, and select, at 1618, a combination of the first transmission for reception and the second transmission for transmission from the set of combinations, based on maximizing the per-combination priority metric. In some aspects, 2012, 2014, and 2016 may be performed by SL resource selection component 198.

In some aspects, the per-combination priority metric may be based on one of: the lowest channel priority for the combination, the highest channel priority for the combination, or the average channel priority for the combination. For example, referring to FIG. 16, the per-combination priority metric (at 1616) may be based on one of: the lowest channel priority for the combination (selected at 1614), the highest channel priority for the combination (selected at 1614), or the average channel priority for the combination (selected at 1614).

In some aspects, to select the first transmission from the first set of transmissions and the second transmission from the second set of transmissions for the FD transmission and reception at 2006, the UE may be configured to: calculate, at 2018, a per-combination priority metric based on the priority of the first transmission and the second transmission; and prioritize, at 2020, overlapping combinations of the first transmission for reception and the second transmission for transmission based on a per combination priority metric; and check, 2022, transmission and reception beam compatibility for the overlapping combinations in descending order of the per-combination priority metric until a threshold number of combinations are determined to have a set of transmission and reception beams that support the FD transmission and reception. For example, referring to FIG. 16, UE 1602 calculates, at 1620, a per-combination priority metric based on the priority of the first transmission and the second transmission, prioritize, at 1622, overlapping combinations of the first transmission for reception and the second transmission for transmission based on a per combination priority metric, and check, 1624, transmission and reception beam compatibility for the overlapping combinations in descending order of the per-combination priority metric until a threshold number of combinations are determined to have a set of transmission and reception beams that support the FD transmission and reception. In some aspects, 2018, 2020, and 2022 may be performed by SL resource selection component 198.

In some aspects, the first transmission and the second transmission may be selected based on at least one of: the first transmission is for sidelink reception via a first RAT and the second transmission is for sidelink transmission via a second RAT, the first transmission is for the reception of a first channel type and the second transmission is for transmission of the first channel type, the first transmission is a first sidelink transmission and the second transmission is a second sidelink transmission, the first transmission is a downlink transmission and the second transmission is the sidelink transmission, or the first transmission is the sidelink transmission and the second transmission is an uplink transmission. For example, referring to FIG. 16, the first transmission (at 1626) and the second transmission (at 1628) may be selected based on at least one of: the first transmission (at 1626) is for sidelink reception via a first RAT and the second transmission (at 1628) is for sidelink transmission via a second RAT, the first transmission (at 1626) is for the reception of a first channel type and the second transmission (at 1628) is for transmission of the first channel type, the first transmission (at 1626) is a first sidelink transmission and the second transmission (at 1628) is a second sidelink transmission, the first transmission is a downlink transmission (at 1626) and the second transmission (at 1628) is the sidelink transmission, or the first transmission (at 1626) is the sidelink transmission and the second transmission (at 1628) is an uplink transmission.

In some aspects, the priority may be based on at least one of: SCI scheduling at least one of the first transmission or the second transmission, DCI scheduling at least one of the first transmission or the second transmission, the MAC-CE scheduling or activating at least one of the first transmission or the second transmission, an RRC configuration, a defined rule, or an association between a feedback channel and a channel for which feedback is provided. For example, referring to FIG. 16, the priority (at 1612) may be based on at least one of: SCI scheduling at least one of the first transmission (at 1626) or the second transmission (at 1628), DCI scheduling at least one of the first transmission (at 1626) or the second transmission (at 1628), the MAC-CE scheduling or activating at least one of the first transmission (at 1626) or the second transmission (at 1628), an RRC configuration, a defined rule, or an association between a feedback channel and a channel for which feedback is provided.

In some aspects, the priority may be based on a common rule for HD communication and FD communication. For example, referring to FIG. 16, the priority (at 1612) may be based on a common rule for HD communication and FD communication.

In some aspects, the priority may be based on an FD prioritization rule applied for one or more resources for which FD communication is enabled. For example, referring to FIG. 16, the priority (at 1612) may be based on an FD prioritization rule applied for one or more resources for which FD communication is enabled.

At 2002, the UE may receive an indication of the FD prioritization rule from a network node or a second UE. For example, referring to FIG. 16, UE 1602 may receive, at 1610 an indication of the FD prioritization rule from a network node (base station 1604) or a second UE (e.g., UE 1606). In some aspects, 2002 may be performed by SL resource selection component 198.

At 2010, the UE may transmit an indication of the FD prioritization rule applied by the UE. For example, referring to FIG. 16, UE 1602 may transmit, at 1630, an indication of the FD prioritization rule applied by UE 1602. UE 1602 may transmit the indication to a base station or a UE (e.g., UE 1606).

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include a cellular baseband processor 2124 (also referred to as a modem) coupled to one or more transceivers 2122 (e.g., cellular RF transceiver). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may cach include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the device 350 and may include the memory 360 and/or at least one of the TX processor 368, the RX processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., see device 350 of FIG. 3) and include the additional modules of the apparatus 2104.

As discussed supra, in some aspects, the component 198 may be configured to monitor for sidelink resource reservations in slots belonging to a sidelink resource pool during a sensing window including one or more slots in which the UE transmits, an inclusion of the one or more slots being based on a condition for sidelink FD communication; and transmit a sidelink transmission using a resource selected from a subset of candidate sidelink resources in the sidelink resource pool after monitoring for the sidelink resource reservations. In some aspects, the component 198 may be configured to receive scheduling for a first set of transmissions to be received by the UE that will overlap in time with a second set of transmissions to be transmitted by the UE; select a first transmission from the first set of transmissions and a second transmission from the second set of transmissions for FD transmission and reception based on FD compatibility of transmission and reception beams and priority of the first transmission and the second transmission; and receive the first transmission while transmitting the second transmission based on FD operation. The component 198 may be further configured to perform any of the aspects described in connection with the flowcharts in FIG. 17 and FIG. 18, and/or performed by the UE 1502 in FIG. 15. The component 198 may be within the cellular baseband processor 2124, the application processor 2106, or both the cellular baseband processor 2124 and the application processor 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, includes means for monitoring for sidelink resource reservations in slots belonging to a sidelink resource pool during a sensing window including one or more slots in which the UE transmits, an inclusion of the one or more slots being based on a condition for sidelink FD communication, and means for transmitting a sidelink transmission using a resource selected from a subset of candidate sidelink resources in the sidelink resource pool after monitoring for the sidelink resource reservations. In one configuration, the apparatus 2104 may include means for receiving scheduling for a first set of transmissions to be received by the UE that will overlap in time with a second set of transmissions to be transmitted by the UE, means for selecting a first transmission from the first set of transmissions and a second transmission from the second set of transmissions for FD transmission and reception based on FD compatibility of transmission and reception beams and priority of the first transmission and the second transmission, and means for receiving the first transmission while transmitting the second transmission based on FD operation. The apparatus 2104 may further include means for performing any of the aspects described in connection with the flowcharts in FIG. 17 and FIG. 18, and/or aspects performed by the UE 1502 in FIG. 15. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

This disclosure provides a method for wireless communication at a UE. In some aspects, the method may include monitoring for sidelink resource reservations in slots belonging to a sidelink resource pool during a sensing window including one or more slots in which the UE transmits, an inclusion of the one or more slots being based on a condition for sidelink FD communication; and transmitting a sidelink transmission using a resource selected from a subset of candidate sidelink resources in the sidelink resource pool after monitoring for the sidelink resource reservations. In some aspects, the method may include receiving scheduling for a first set of transmissions to be received by the UE that will overlap in time with a second set of transmissions to be transmitted by the UE; selecting a first transmission from the first set of transmissions and a second transmission from the second set of transmissions for FD transmission and reception based on FD compatibility of transmission and reception beams and priority of the first transmission and the second transmission; and receiving the first transmission while transmitting the second transmission based on FD operation. The methods improve the efficiency and performance of SL communication by enabling FD operation and facilitating better resource selection and channel prioritization.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim clement is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include monitoring for sidelink resource reservations in slots belonging to a sidelink resource pool during a sensing window including one or more slots in which the UE transmits, an inclusion of the one or more slots being based on a condition for sidelink FD communication; and transmitting a sidelink transmission using a resource selected from a subset of candidate sidelink resources in the sidelink resource pool after monitoring for the sidelink resource reservations.

Aspect 2 is the method of aspect 1, where the method may further include determining that the condition for the sidelink FD communication is met. The UE may monitor for the sidelink resource reservations during the one or more slots in which the UE transmits based on the condition for the sidelink FD communication being met.

Aspect 3 is the method of aspect 1, where the method may further include monitoring for the sidelink resource reservations in additional slots belonging to the sidelink resource pool excluding at least one slot in which the UE transmits based on the condition for the sidelink FD communication not being met.

Aspect 4 is the method of aspect 1, where the method may further include receiving at least one sidelink resource reservation in the one or more slots in which the UE transmits.

Aspect 5 is the method of aspect 1, where the condition for the sidelink FD communication may include a self-interference metric.

Aspect 6 is the method of aspect 5, where the condition for the sidelink FD communication may include a quality metric for at least a subset of candidate sidelink channels meeting a threshold during measurement resources.

Aspect 7 is the method of aspect 6, where the threshold may be a defined or configured value.

Aspect 8 is the method of aspect 6, where the threshold may be based on a reference channel during a time period that the UE does not transmit.

Aspect 9 is the method of aspect 6, where the method may further include measuring the quality metric for each candidate sidelink channel during the one or more slots in which the UE transmits or predicts the quality metric for each candidate sidelink channel based on one or more past measurements; and comparing the quality metric to the threshold to determine if the condition for the sidelink FD communication is met. The quality metric may include at least one of: the RSRP, the SINR, the BLER, the RSSI, the total interference plus noise, or the self-interference measurement.

Aspect 10 is the method of any of aspects 1 to 9, where the condition for the sidelink FD communication may be based on a configured set of transmission and reception parameters for the UE.

Aspect 11 is the method of aspect 10, where the configured set of transmission and reception parameters for the condition for the sidelink FD communication may include one or more of: the MCS, the number of layers, the TCI state, the transmission and reception power, the transmission and reception timing, or the guard band in frequency between transmission and reception.

Aspect 12 is the method of any of aspects 1 to 11, where the method may further include selecting. based on the condition for the sidelink FD communication, a reception resource for receiving sidelink communication overlapping in time with the resource in which the sidelink transmission is transmitted; and receiving the sidelink communication in the reception resource that overlaps in time with the resource in which the sidelink transmission is transmitted.

Aspect 13 is the method of any of aspects 1 to 12, where the method may further include selecting, based on the condition for the sidelink FD communication, the resource for the sidelink transmission that overlaps in time with scheduled resources for the reception of sidelink communication.

Aspect 14 is the method of aspect 13, where the condition for the SL FD communication may be based, at least in part, on a subset of resources defined, configured, or otherwise indicated as being allowed for the sidelink FD communication.

Aspect 15 is the method of any of aspects 1 to 14, where the method may further include transmitting inter-UE coordination information indicating a preferred resource set that includes, based on the condition for the sidelink FD communication, at least one time resource in which the UE will transmit.

Aspect 16 is the method of any of aspects 1 to 14, where the method may further include transmitting inter-UE coordination information indicating a non-preferred resource set that excludes, based on the condition for the sidelink FD communication, at least one time resource in which the UE will transmit.

Aspect 17 is the method of any of aspects 1 to 16, where the method may further include determining a resource conflict for inter-UE coordination information excluding, based on the condition for the sidelink FD communication, at least one time resource in which the UE will transmit.

Aspect 18 is the method of any of aspects 1 to 17, where the method may further include transmitting inter-UE coordination information based on the condition for the sidelink FD communication, the inter-UE coordination information indicating at least one of a preferred resource set, a non-preferred resource set, or a resource conflict indication, and further indicating one or more of: the condition for the sidelink FD communication, a measurement associated with the condition for the sidelink FD communication, at least one selected resource for transmission by the UE, or a priority of the transmission by the UE.

Aspect 19 is the method of any of aspects 1 to 18, where the method may further include applying a priority rule for transmission of a first channel or a first reference signal that will overlap in time with the reception of a second channel or a second reference signal based on support for FD communication and a transmission and reception beam pair.

Aspect 20 is an apparatus for wireless communication at a UE, including: a memory; and at least one processor coupled to the memory and, based at least in part on information stored in the memory, the at least one processor is configured to perform the method of any of aspects 1-19.

Aspect 21 is the apparatus of aspect 20, further including at least one of a transceiver or an antenna coupled to the at least one processor and configured to transmit the sidelink transmission.

Aspect 22 is an apparatus for wireless communication including means for implementing the method of any of aspects 1-19.

Aspect 23 is a computer-readable medium (e.g., a non-transitory computer-readable medium) storing computer executable code, where the code when executed by a processor causes the processor to implement the method of any of aspects 1-19.

Aspect 24 is a method of wireless communication at a UE. The method may include receiving scheduling for a first set of transmissions to be received by the UE that will overlap in time with a second set of transmissions to be transmitted by the UE; selecting a first transmission from the first set of transmissions and a second transmission from the second set of transmissions for FD transmission and reception based on FD compatibility of transmission and reception beams and priority of the first transmission and the second transmission; and receiving the first transmission while transmitting the second transmission based on FD operation.

Aspect 25 is the method of aspect 24, where the first set of transmissions to be received by the UE may include at least one first sidelink channel or first reference signal and the second set of transmissions to be transmitted by the UE includes at least one second sidelink channel or second reference signal.

Aspect 26 is the method of any of aspects 24 to 25, where selecting the first transmission from the first set of transmissions and the second transmission from the second set of transmissions for the FD transmission and reception may include: selecting a set of combinations of first transmissions and second transmissions, where cach combination has a transmission beam and reception beam pair that support the FD transmission and reception; calculating a per-combination priority metric based on the priority of the first transmission and the second transmission; and selecting a combination of the first transmission for reception and the second transmission for transmission from the set of combinations, based on maximizing the per-combination priority metric.

Aspect 27 is the method of aspect 24, where the per-combination priority metric may be based on one of: a lowest channel priority for the combination, a highest channel priority for the combination, or an average channel priority for the combination.

Aspect 28 is the method of any of aspects 24 to 25, where selecting the first transmission from the first set of transmissions and the second transmission from the second set of transmissions for the FD transmission and reception may include: calculating a per-combination priority metric based on the priority of the first transmission and the second transmission; and prioritizing overlapping combinations of the first transmission for reception and the second transmission for transmission based on a per combination priority metric; and checking transmission and reception beam compatibility for the overlapping combinations in descending order of the per-combination priority metric until a threshold number of combinations are determined to have a set of transmission and reception beams that support the FD transmission and reception.

Aspect 29 is the method of any of aspects 24 to 28, where the first transmission and the second transmission may be selected based on at least one of: the first transmission is for sidelink reception via a first RAT and the second transmission is for sidelink transmission via a second RAT, the first transmission is for the reception of a first channel type and the second transmission is for transmission of the first channel type, the first transmission is a first sidelink transmission and the second transmission is a second sidelink transmission, the first transmission is a downlink transmission and the second transmission is the sidelink transmission, or the first transmission is the sidelink transmission and the second transmission is an uplink transmission.

Aspect 30 is the method of any of aspects 24 to 28, where the priority may be based on at least one of: SCI scheduling at least one of the first transmission or the second transmission, DCI scheduling at least one of the first transmission or the second transmission, a MAC-CE scheduling or activating at least one of the first transmission or the second transmission, an RRC configuration, a defined rule, or an association between a feedback channel and a channel for which feedback is provided.

Aspect 31 is the method of any of aspects 24 to 28, where the priority may be based on a common rule for HD communication and FD communication.

Aspect 32 is the method of any of aspects 24 to 28, where the priority may be based on an FD prioritization rule applied for one or more resources for which FD communication is enabled.

Aspect 33 is the method of aspect 32, where the method may further include receiving an indication of the FD prioritization rule from a network node or a second UE.

Aspect 34 is the method of aspect 32, where the method may further include transmitting an indication of the FD prioritization rule applied by the UE.

Aspect 35 is an apparatus for wireless communication at a network entity, including: a memory; and at least one processor coupled to the memory and, based at least in part on information stored in the memory, the at least one processor is configured to perform the method of any of aspects 24-34.

Aspect 36 is the apparatus of aspect 35, further including at least one of a transceiver or an antenna coupled to the at least one processor and configured to receive the first transmission.

Aspect 37 is an apparatus for wireless communication including means for implementing the method of any of aspects 24-34.

Aspect 38 is a computer-readable medium (e.g., a non-transitory computer-readable medium) storing computer executable code, where the code when executed by a processor causes the processor to implement the method of any of aspects 24-34.

What is claimed is:

1. An apparatus of wireless communication at a user equipment (UE), comprising:
memory; and
at least one processor coupled to the memory and, based at least in part on information stored in the memory, the at least one processor is configured to:
monitor for sidelink resource reservations in slots belonging to a sidelink resource pool during a sensing window including one or more slots in which the UE transmits, an inclusion of the one or more slots being based on a condition for sidelink full-duplex (FD) communication; and
transmit a sidelink transmission using a resource selected from a subset of candidate sidelink resources in the sidelink resource pool after monitoring for the sidelink resource reservations.

2. The apparatus of claim 1, further comprising a transceiver coupled to the at least one processor, wherein, to transmit the sidelink transmission, the at least one processor is configured to transmit the sidelink transmission via the transceiver, and wherein the at least one processor is further configured to:
determine that the condition for the sidelink FD communication is met, wherein the UE monitors for the sidelink resource reservations during the one or more slots in which the UE transmits based on the condition for the sidelink FD communication being met.

3. The apparatus of claim 1, wherein the at least one processor is further configured to:
monitor for the sidelink resource reservations in additional slots belonging to the sidelink resource pool excluding at least one slot in which the UE transmits based on the condition for the sidelink FD communication not being met.

4. The apparatus of claim 1, wherein the at least one processor is further configured to:
receive at least one sidelink resource reservation in the one or more slots in which the UE transmits.

5. The apparatus of claim 1, wherein the condition for the sidelink FD communication includes a self-interference metric.

6. The apparatus of claim 5, wherein the condition for the sidelink FD communication includes a quality metric for at least a subset of candidate sidelink channels meeting a threshold during measurement resources.

7. The apparatus of claim 6, wherein the threshold is a defined or configured value.

8. The apparatus of claim 6, wherein the threshold is based on a reference channel during a time period that the UE does not transmit.

9. The apparatus of claim 6, wherein the at least one processor is further configured to:
measure the quality metric for each candidate sidelink channel during the one or more slots in which the UE transmits, or
predict the quality metric for each candidate sidelink channel based on one or more past measurements; and
compare the quality metric to the threshold to determine if the condition for the sidelink FD communication is met, wherein the quality metric includes at least one of:
a reference signal received power (RSRP),
a Signal-to-Interference-plus-Noise Ratio (SINR),
a block error rate (BLER),
a received signal strength indicator (RSSI),
a total interference plus noise, or
a self-interference measurement.

10. The apparatus of claim 1, wherein the condition for the sidelink FD communication is based on a configured set of transmission and reception parameters for the UE.

11. The apparatus of claim 10, wherein the configured set of transmission and reception parameters for the condition for the sidelink FD communication includes one or more of:
a modulation and coding scheme (MCS),
a number of layers,
a transmission configuration indicator (TCI) state,
a transmission and reception power,
a transmission and reception timing, or
a guard band in frequency between transmission and reception.

12. The apparatus of claim 1, wherein the at least one processor is further configured to:
select, based on the condition for the sidelink FD communication, a reception resource for receiving sidelink communication overlapping in time with the resource in which the sidelink transmission is transmitted; and
receive the sidelink communication in the reception resource that overlaps in time with the resource in which the sidelink transmission is transmitted.

13. The apparatus of claim 1, wherein the at least one processor is further configured to:
select, based on the condition for the sidelink FD communication, the resource for the sidelink transmission that overlaps in time with scheduled resources for reception of sidelink communication.

14. The apparatus of claim 13, wherein the condition for the sidelink FD communication is based, at least in part, on a subset of resources defined, configured, or otherwise indicated as being allowed for the sidelink FD communication.

15. The apparatus of claim 1, wherein the at least one processor is further configured to:
transmit inter-UE coordination information indicating a preferred resource set that includes, based on the condition for the sidelink FD communication, at least one time resource in which the UE will transmit.

16. The apparatus of claim 1, wherein the at least one processor is further configured to:
transmit inter-UE coordination information indicating a non-preferred resource set that excludes, based on the condition for the sidelink FD communication, at least one time resource in which the UE will transmit.

17. The apparatus of claim 1, wherein the at least one processor is further configured to:
determine a resource conflict for inter-UE coordination information excluding, based on the condition for the sidelink FD communication, at least one time resource in which the UE will transmit.

18. The apparatus of claim 1, wherein the at least one processor is further configured to:
transmit inter-UE coordination information based on the condition for the sidelink FD communication, the inter-UE coordination information indicating at least one of a preferred resource set, a non-preferred resource set, or a resource conflict indication, and further indicating one or more of:
the condition for the sidelink FD communication,
a measurement associated with the condition for the sidelink FD communication,
at least one selected resource for transmission by the UE, or
a priority of the transmission by the UE.

19. The apparatus of claim 1, wherein the at least one processor is further configured to:
apply a priority rule for transmission of a first channel or a first reference signal that will overlap in time with reception of a second channel or a second reference signal based on support for FD communication and a transmission and reception beam pair.

20. An apparatus of wireless communication at a user equipment (UE), comprising:
memory; and
at least one processor coupled to the memory and, based at least in part on information stored in the memory, the at least one processor is configured to:
receive scheduling for a first set of transmissions to be received by the UE that will overlap in time with a second set of transmissions to be transmitted by the UE;
select a first transmission from the first set of transmissions and a second transmission from the second set of transmissions for full-duplex (FD) transmission and reception based on FD compatibility of transmission and reception beams and priority of the first transmission and the second transmission; and
receive the first transmission while transmitting the second transmission based on FD operation.

21. The apparatus of claim 20, further comprising a transceiver coupled to the at least one processor, wherein, to receive the first transmission, the at least one processor is configured to receive the first transmission via the transceiver, and wherein the first set of transmissions to be received by the UE includes at least one first sidelink channel or first reference signal and the second set of transmissions to be transmitted by the UE includes at least one second sidelink channel or second reference signal.

22. The apparatus of claim 20, wherein, to select the first transmission from the first set of transmissions and the second transmission from the second set of transmissions for the FD transmission and reception, the at least one processor is configured to:
select a set of combinations of first transmissions and second transmissions, wherein each combination has a transmission beam and reception beam pair that support the FD transmission and reception;
calculate a per-combination priority metric based on the priority of the first transmission and the second transmission; and
select a combination of the first transmission for reception and the second transmission for transmission from the set of combinations, based on maximizing the per-combination priority metric.

23. The apparatus of claim 22, wherein the per-combination priority metric is based on one of:
a lowest channel priority for the combination,
a highest channel priority for the combination, or
an average channel priority for the combination.

24. The apparatus of claim 20, wherein, to select the first transmission from the first set of transmissions and the second transmission from the second set of transmissions for the FD transmission and reception, the at least one processor is configured to:
calculate a per-combination priority metric based on the priority of the first transmission and the second transmission; and prioritize overlapping combinations of the first transmission for reception and the second transmission for transmission based on a per combination priority metric; and
check transmission and reception beam compatibility for the overlapping combinations in descending order of the per-combination priority metric until a threshold number of combinations are determined to have a set of transmission and reception beams that support the FD transmission and reception.

25. The apparatus of claim 20, wherein the first transmission and the second transmission are selected based on at least one of:
the first transmission is for sidelink reception via a first radio access technology (RAT) and the second transmission is for sidelink transmission via a second RAT, the first transmission is for reception of a first channel type and the second transmission is for transmission of the first channel type,
the first transmission is a first sidelink transmission and the second transmission is a second sidelink transmission,
the first transmission is a downlink transmission and the second transmission is the sidelink transmission, or
the first transmission is the sidelink transmission and the second transmission is an uplink transmission.

26. The apparatus of claim 20, wherein the priority is based on at least one of:
sidelink control information (SCI) scheduling at least one of the first transmission or the second transmission,
downlink control information (DCI) scheduling at least one of the first transmission or the second transmission,
a medium access control-control element (MAC-CE) scheduling or activating at least one of the first transmission or the second transmission,
a radio resource control (RRC) configuration,
a defined rule, or
an association between a feedback channel and a channel for which feedback is provided.

27. The apparatus of claim 20, wherein the priority is based on a common rule for half-duplex (HD) communication and FD communication.

28. The apparatus of claim 20, wherein the priority is based on an FD prioritization rule applied for one or more resources for which FD communication is enabled.

29. The apparatus of claim 28, wherein the at least one processor is further configured to:
receive an indication of the FD prioritization rule from a network node or a second UE.

30. The apparatus of claim 28, wherein the at least one processor is further configured to:
transmit an indication of the FD prioritization rule applied by the UE.
